(19) United States
(12) Patent Application Publication
(10) Pub. No.: US 2015/0032583 A1
(43) Pub. Date: Jan. 29, 2015

(54) METHOD AND SYSTEM FOR TRACKING PROJECT IMPACTS, EVENT IMPACTS, AND ENERGY SAVINGS

(71) Applicant: GridPoint, Inc., Arlington, VA (US)

(72) Inventors: Erin Lehner Mello, Nashville, TN (US); Mark Allen Danzenbaker, Ashburn, VA (US); Kyle Alexander McCarter, Chatham, NJ (US); Kimberly Sharp Bishop, Behesda, MD (US); Elizabeth Bilyeu Wilkinson, Hanover, MA (US); Matthew James Browning, Roanoke, VA (US)

(73) Assignee: GidPoint, Inc., Arlington, VA (US)

(21) Appl. No.: 14/201,608

(22) Filed: Mar. 7, 2014

Related U.S. Application Data
(60) Provisional application No. 61/859,281, filed on Jul. 28, 2013.

(51) Int. Cl. G06Q 40/00; G06Q 50/06

(52) U.S. Cl. CPC G06Q 40/12; G06Q 50/06
USPC 705/30; 700/291

(57) ABSTRACT

A method assesses an energy impacting event at a facility using an energy management system. One or more energy consuming endpoints of the facility are sub-metered and data from the sub-metered endpoints is transmitted to the energy management system. A project is created within the EMS by entering project definition attributes including at least a site name, a project name, and a start date. Data from one or more sub-metered channels and a project indicator is displayed. The displayed project indicator is located at a point corresponding to its project start time. A further method tracks the progress of energy saving project at a facility using an energy management system. The project definition attributes further include one or more sub-metered channels, baseline usage data, and an energy related goal. An energy impact value is calculated by subtracting the actual sub-metered usage data from the baseline data and a determination is made whether the energy impact value meets or exceeds the energy goal. The baseline usage data, the energy goal data, the actual sub-metered data, and an indication of whether the energy goal was met are displayed. A further method tracks the financial progress of energy saving project at a facility using an energy management system. The project definition attributes further include one or more capital investment outflow values, a discount rate, and an energy cost rate. Net actual project cash flows and the net project goal cash flows are both plotted against a time scale and periodically displayed. An estimated net present value and net present value are periodically calculated and displayed.

This non-provisional patent application claims priority to U.S. Provisional Patent Application No. 61,859,281, filed on Jul. 28, 2013, which is incorporated herein by reference in its entirety.

### BACKGROUND OF THE INVENTION

1. Field of the Invention

The invention relates generally to systems and methods for energy savings tracking using an energy management system. More specifically, the invention relates to tracking energy impacting events, correlating those events to energy related channels, and measuring the value of capital and operational expenditure projects.

2. Description of the Related Art

An energy management system (EMS) typically monitors and, in some cases, controls multiple endpoints at a facility (building) such as HVAC units, lighting panels, natural gas consumption, refrigeration, temperature monitors, and other power consuming or monitoring devices located throughout one or more zones of a building or buildings. The monitored data is transmitted to a central control and monitoring EMS that can be remote or local to the building or buildings being monitored. The monitored data is typically presented to a user/operator overseeing the operation of one or more of the buildings via a computer monitor coupled to the EMS. The operator can view energy usage, identify alarm conditions, and take actions to mitigate problems associated with the energy usage, or as disclosed in U.S. application Ser. No. 13/842,901, which is incorporated herein in its entirety, the alarm conditions. Automated energy saving algorithms can also be implemented that make automated curtailment choices to control that control facility endpoints based on the sub-metering data, as disclosed in U.S. application Ser. No. 13/425,195, which is incorporated herein in its entirety. Operators can also collect vast amounts of endpoint data and analyze it to understand how much energy is being consumed by each facility, as well as sub-portions (e.g., zone and asset) of each facility. This endpoint data can provide insight into how energy is being consumed as well as enabling operators to better understand how various events impact energy use, thus enabling operators to make better energy management choices, relative to both capital and operational expenditure projects.

As can be appreciated, for a business that is trying to understand its energy usage and to prioritize its energy savings initiatives, the large amount and wide variety of sub-metered (e.g., circuit level) data generated by the monitoring systems of one or more facilities can be overwhelming. What is needed is a system that allows an operator to define and track energy impacting events and correlate those events to one or more sub-metered data channels. Also needed is a system that allows an operator to easily create and track the effectiveness of energy impacting projects within one or more business facilities. Further needed is a system for visually isolating the energy impacting effects of individual projects and reducing those results to financial terms. Yet further needed is a way to easily rank various energy impacting projects to determine which ones should be implemented on a fleet-wide scale.

### BRIEF SUMMARY OF THE INVENTION

Various embodiments of the invention solve the above-mentioned problems by providing an energy management system with the ability to create, track, analyze, monetize, and prioritize energy-related projects and other energy impacting events, particularly with respect to capital and operational expenditures.

In an embodiment, an EMS collects sub-metered data from one or more energy consuming devices and stores it in a database. An operator creates a project defined by a project site, project type, and start date. The EMS provides the operator with a visual representation of sub-metered data associated with the start date, including a synopsis and time representation of the project and any other projects associated with the start date.

In another embodiment, an operator creates a project defined by a project site, project type, start date, sub-meter channel or channels, baseline data, and goal data. The EMS provides the operator with a visual representation of the actual sub-metered data, baseline data, and goal data. Metrics identifying when the goal has been or will be met are displayed.

In yet another embodiment, an operator creates a project defined by a project site, project type, start date, sub-meter channel or channels, baseline data, goal data, and financial metrics. The EMS provides the operator with a visual representation of the actual sub-metered data, baseline data, and goal data. The EMS further calculates a financial metric that represents the value of the project. The EMS further provides a display of the financial metrics on a daily or monthly basis.

### BRIEF DESCRIPTION OF THE DRAWINGS

These and other features, aspects, and advantages of the present invention will become better understood with reference to the following description and appended claims, and accompanying drawings where:

FIG. 1 is a block diagram illustrating an energy management system controlling and monitoring multiple building sites.

FIG. 2 is a block diagram illustrating EMS site hardware monitoring various endpoints at a physical site with specific detail of HVAC and lighting control.

FIG. 3 is a block diagram illustrating a simplified configuration of a site controller and monitor at physical site.

FIG. 4 is a block diagram illustrating a server system providing remote information access, and control, to a facility manager and EMS provider.

FIG. 5 is a user interface for creating and editing projects.

FIG. 6 is a graphical representation of an illustrative energy-impacting one-day event overlaid under average hourly demand and voltage channel data.

FIG. 7 is a graphical representation of additional data channels associated with an illustrative energy-impacting multi-day event showing daily average demand data.

FIG. 8 is a graphical representation of multiple channels associated with multiple projects at a single site.

FIG. 9 is a graphical representation of a channel associated with an alarm.

FIG. 10 is a user interface for entering and editing baseline data.

FIG. 11 is an illustration of a monitored lighting control retrofit.

FIG. 12 is a user interface for entering and editing project goals.

FIG. 13 is a graphical representation of tracking goal progress showing monthly usage vs. cumulative project savings.

FIG. 14 is a graphical representation of daily kWh usage vs. baseline and goal data for a month.

FIG. 15 is a user interface for entering and editing financial parameters.

FIG. 16 is a graphical representation of the cash flows of a project.

FIG. 17 is a financial breakeven chart.

FIG. 18 is a display of a project inventory.

FIG. 19 is a user interface for choosing columns to display in the project inventory

FIG. 20 is a project tracking report showing daily comparison of actual usage for the base period vs. compare period.

FIG. 21 is a weather normalized project tracking report showing daily comparison of weather-normalized predicted vs. actual usage.

FIG. 22 is a weather normalized project tracking report showing average day-of-week comparison of weather-normalized predicted vs. actual usage.

FIG. 23 is a weather normalized project tracking report showing month-of-year comparison of weather-normalized predicted vs. actual usage.

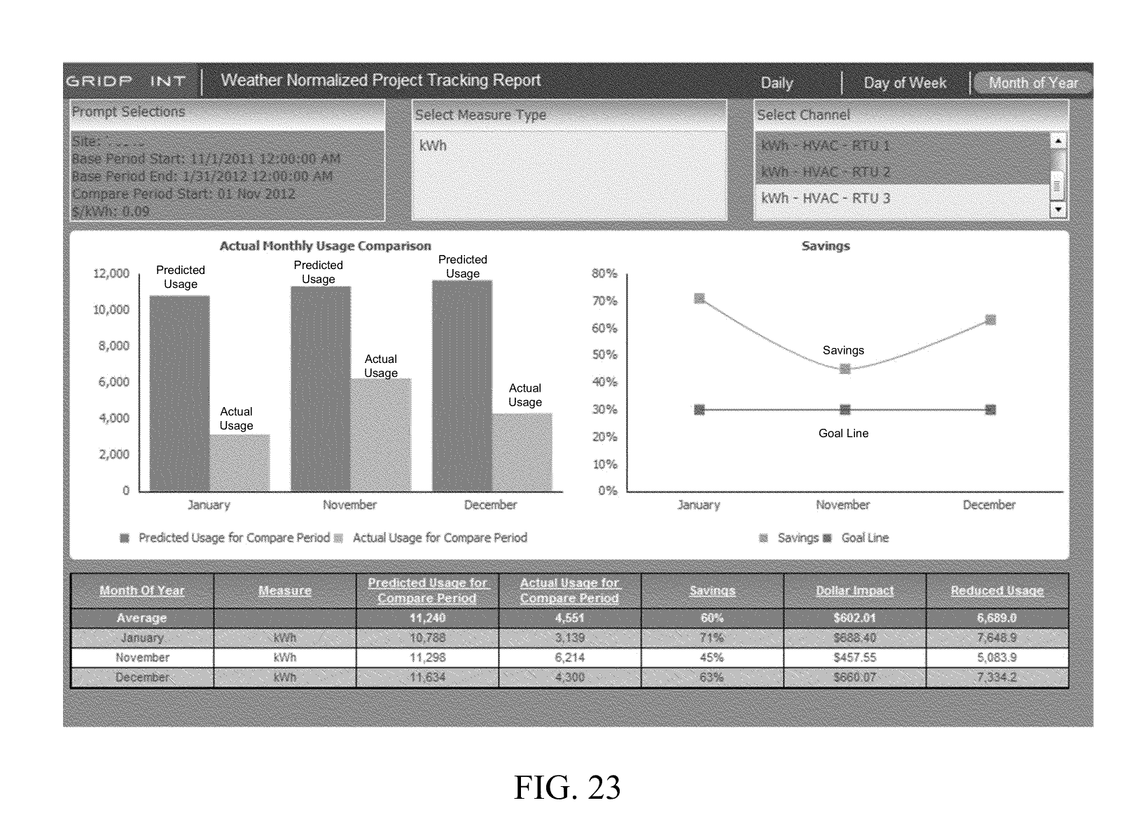

Some figures illustrate diagrams of the functional blocks of various embodiments. The functional blocks illustrated herein are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk or the like). Similarly, the programs may be standalone programs, may be incorporated as subroutines in an operating system, may be functions in an installed software package, and may reside in collocated or remotely located servers. It should be understood that the various embodiments are not limited to the arrangements and instrumentalities shown in the drawings.

### DETAILED DESCRIPTION OF THE INVENTION

The present invention may be understood more readily by reference to the following detailed description of preferred embodiments of the invention as well as to the examples included therein. Embodiments of the invention provide systems, methods, and software, for the creation, editing, tracking, evaluation, monetization, and prioritization of projects related to energy or other operational metric.

Each physical site has installed in it monitoring hardware that is part of the energy management system. The physical site can also have additional hardware to control energy using devices. The monitoring hardware measures near real-time (for example, every 1 or 15 minute) main load and circuit level load power demand and voltage, and may also receive data from other devices that measure temperature, humidity, CO2, and other metrics. Data originating from a device is considered a data “channel.” Further, channels may be logically grouped into other channels, for example, all HVAC units at a building site or all temperature settings of a group of buildings within a region. The monitoring equipment sends the channel data to the energy management system software to be stored and processed. Preferably, this incoming data should include, or have associated with it, commonly defined channel attributes, sometimes referred to as “metadata”, such as data type, measurement type, unit of measure, and the like, so that each time-series data channel can be leveraged in facility energy use analysis. Using the attributes, channels can be identified, categorized, and aggregated to be used to evaluate energy impacting events and valuating energy impacting projects.

The operator can access the energy management system software remotely using a third party provider, or can do so directly in cases where the software is installed at a user-operated control center. In some cases, the operator may respond to energy use data and alarms by causing control signals to be sent to the energy management system to affect energy usage at one or more of its sites. The control equipment can respond to commands from the energy management system software to regulate selected sub-loads as needed. Using the energy management software, the user can also enable the EMS to automatically control sub-loads at each site according to specific schedules.

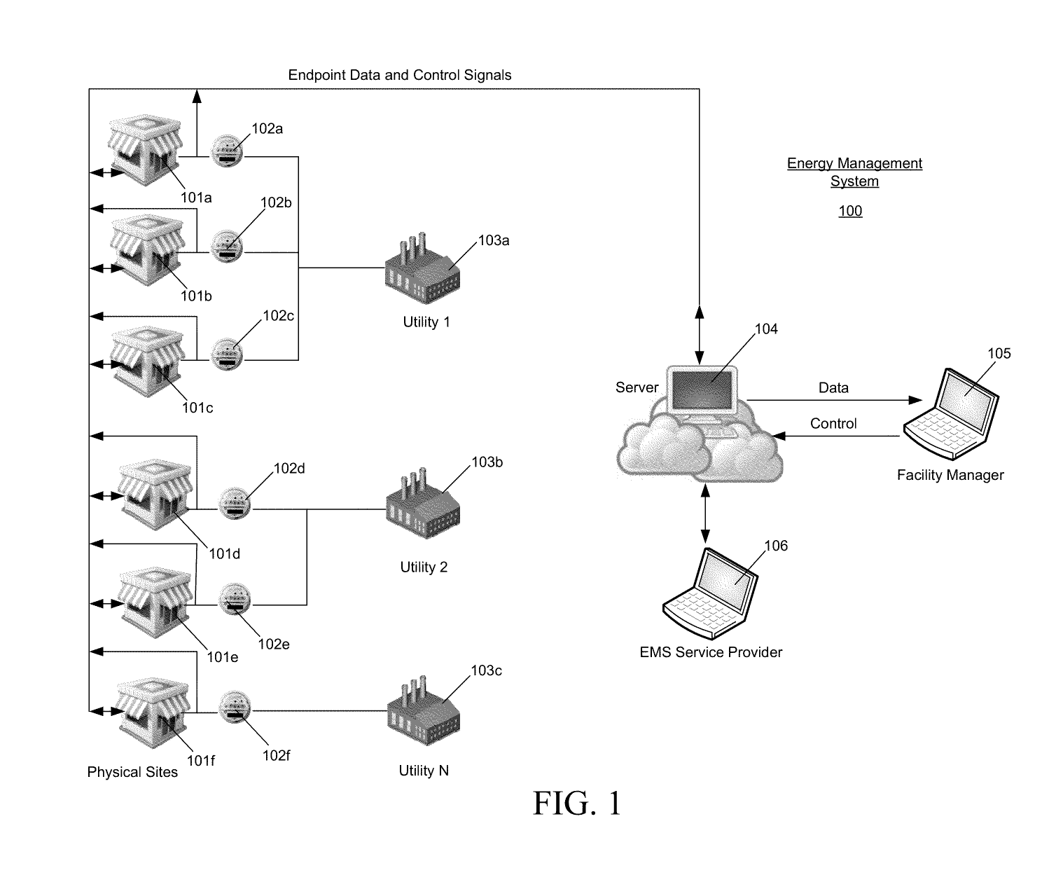

FIG. 1 is an illustration of an energy management system 100 for controlling and monitoring multiple building sites 101a-101f. In a typical system, multiple building sites 101a-101f are spread across different geographic areas, and sometimes receive electric power from an electric utility within each geographic area. For purposes of illustration, electric utilities 103a-103c are shown, but other types of utilities, such as a natural gas utility, could also be included. Utilities 103a-103c typically monitor energy consumption and demand using meters 102a-102f located at the utility side of the interconnection point of building sites 101a-101f, while the EMS typically monitors main line power usage at the facility side of the interconnection points as well as sub-metering multiple end points within the facility itself. Energy demand and consumption data, as well as other non-energy related data is measured by the EMS at each building site and sent back to a central server 104 via network hosted by a third party EMS provider. A system operator, such as a facility manager, has remote access to the EMS servers via wired or wireless connection using a computer terminal 105. The facility manager can receive and view endpoint data from one or more facilities 101a-101f, and if desired, can take responsive or corrective action via the remote server 104. The third-party EMS provider also has access to the EMS, using a terminal 106, for the purpose of providing support, maintenance, and additional services.

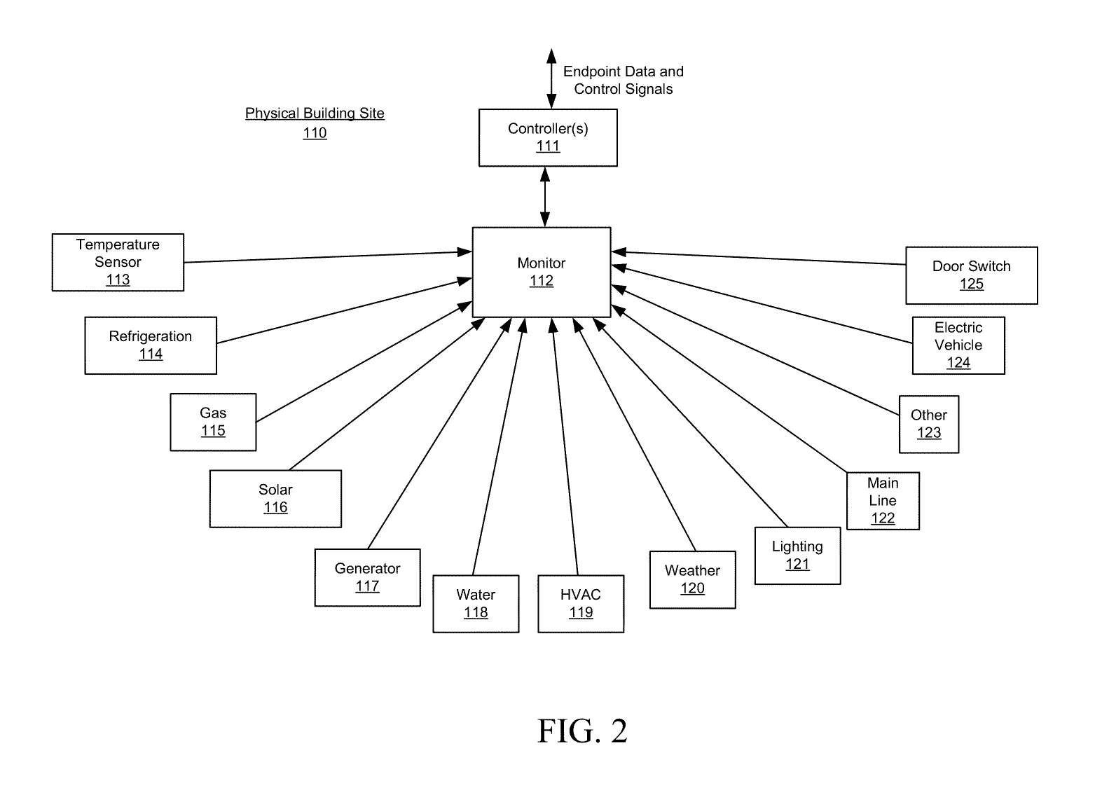

FIG. 2 is an illustration of site hardware monitoring various endpoints, sensors, or data sources 113-125, at a physical building site 110. In particular, each facility is equipped with one or more site controllers 111 communicatively coupled to one or more monitoring devices 112. Any number of parameters can be monitored, including but not limited to main line voltage and current 122, lighting 121, HVAC 119, generators 117, gas flow 115, refrigeration units 114, solar arrays 116, water consumption 118, weather data 120, door switches 125, electric vehicles and electric vehicle charging stations 124, thermostats 113 or other sensing device or data source 123. Monitored data flows from the monitoring devices 112 through the controllers 111 and on to the remote server 104 via a wired or wireless network.

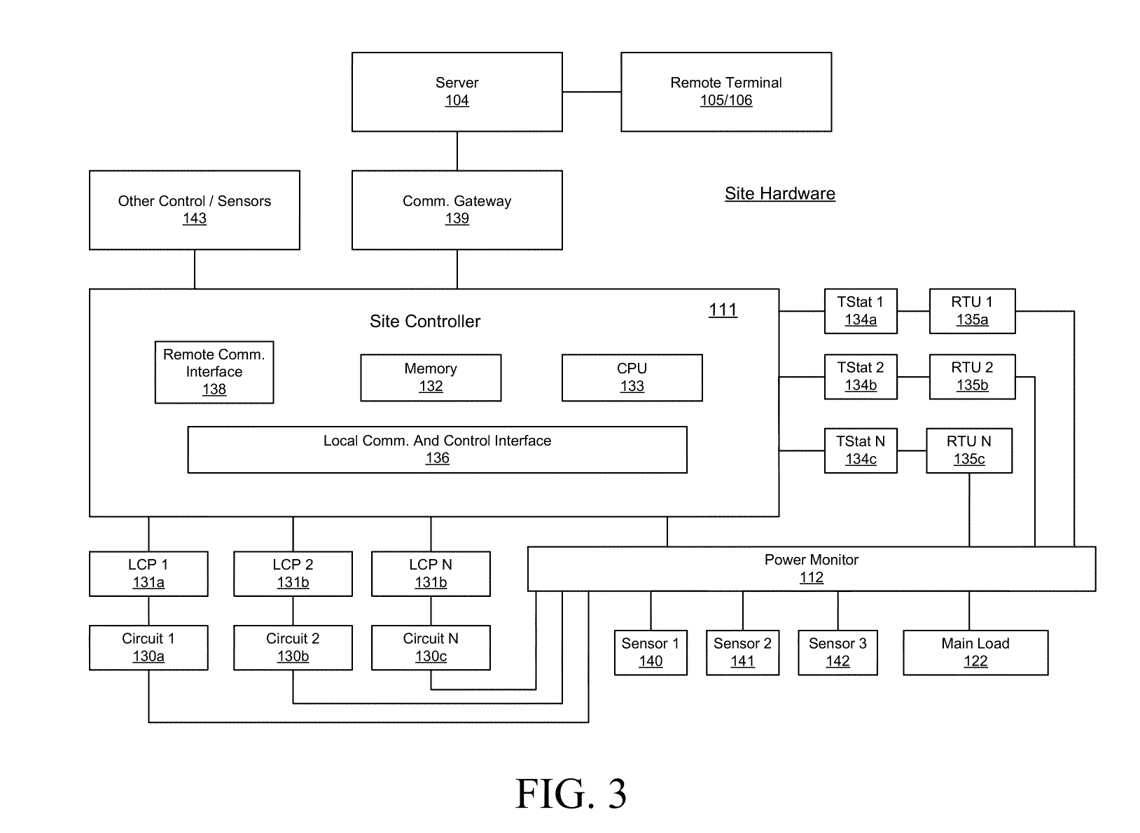

FIG. 3 is a detailed schematic block diagram illustrating typical energy management system hardware installed at a physical building site. A site controller 111 with embedded control algorithms controls multiple electrical loads on circuits 1 through N (130a-130c) via Light Control Panels (LCPs) 1 through N (131a-131c). The site controller 111 is typically wired to common voltages at an electrical distribution panel (not shown) of a building facility via a main line meter (power monitor) 112. The site controller 111 includes memory 132 and a CPU 133 for respectively storing and implementing energy management algorithms. The algorithms accept real-time power and environmental variable measurements (including readings from thermostats TStat 1 through TStat N (134a-134c)) as inputs and determine how to control the power delivered on the circuits 1 through N (130a-130c) and to control set points and other configurable settings such as enabling/disabling compressor stages on TStat 1 through TStat N (135a-135c). The site controller 111 may include a power supply (not shown) and one or more wired or wireless local communication and control interfaces (136) for controlling circuits 1 through N (130a-130c) and TStat 1 through TStat N (134a-134c). Thermostats TStat 1 through TStat N (134a-134c) provide temperature and humidity inputs to the site controller 111, and output control signals to roof-top units RTU 1 through RTU N (137a-137c). A communication interface 138 provides bi-directional communication with a communication gateway 139, which in turn manages wired or wireless communications with a server 104 or remote terminal 105/106.

One or more power monitors 112 are coupled to the site controller either via wired or wireless connection. The power monitor 112 includes hardware and firmware to provide sampling functionality, including multiple analog-to-digital converters for multi-channel fast waveform sampling of inputs such as current and voltage. The power monitor includes wired or wireless communication interfaces, current and voltage monitoring interfaces, memory, CPU, and may also include a power supply. The current and voltage monitoring interfaces connect between the power circuits being monitored and the A/D converter. Each channel may be connected to a separate power circuit to monitor the flow of current through the circuit. The connection is typically made with a current transformer at both a supply (i.e., hot) line and a return (i.e., neutral) line of the power circuit, which provides a waveform signal that is representative of the current flow at the connection point. The power monitor can receive power voltage and current measurements from the main line 122 as well as measurements from any of a number of sensor devices 140-142 or groups of devices, as illustrated in FIG. 2 and described herein. Controller 111 can also receive data directly from other sensors 143.

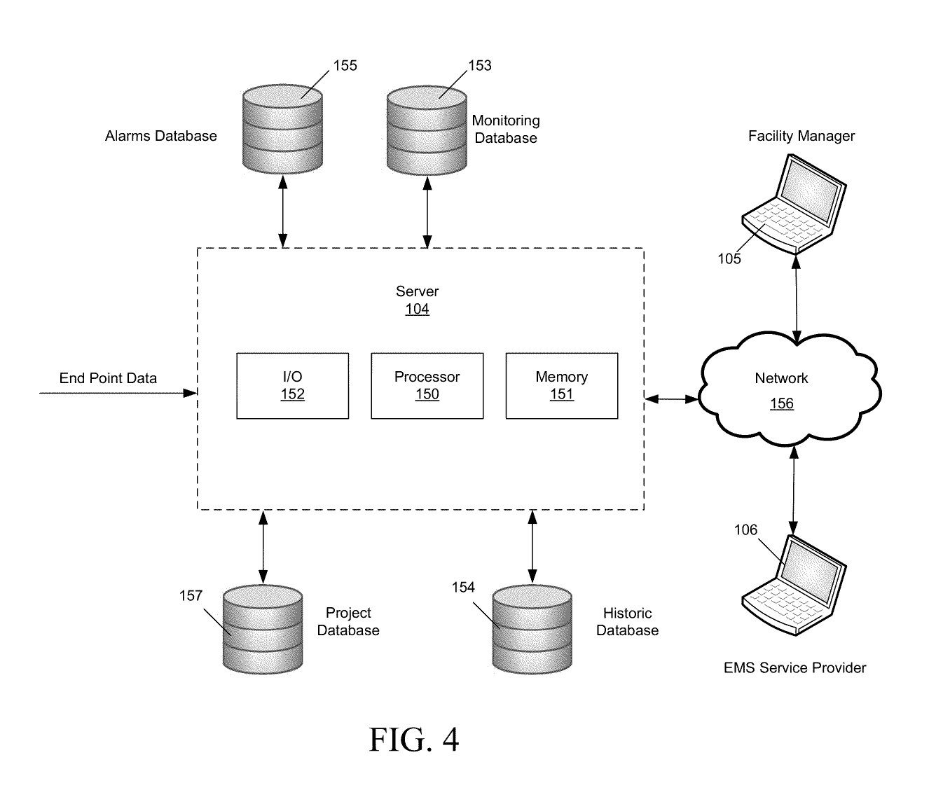

FIG. 4 is an illustration of server system 104 providing remote information access and control to a facility manager and EMS provider. The server 104 includes a processor 150, memory 151, and one or more I/O interfaces 152 for receiving end point data and communicating with the facility manager and/or EMS service provider terminals 105 and 106 via network 156. The server includes one or more databases, including a monitoring database 153 that stores recent endpoint data, a historic database 154 that stores historic data from one or more facilities, an alarms database 155 that stores alarm definitions to which incoming endpoint data and historic data can be applied, a project database 157 for storing the parameters of projects. The memory 151 consists of tangible data and program storage for storing and retrieving instructions for creating, editing, and storing projects and the results of projects. The memory 151 can also include working memory from which to execute the instructions and other software necessary to operate the EMS.

### Tracking Energy & Operational Impacting Events

There are numerous events that can impact energy demand and consumption at a facility. For example, replacing older HVAC equipment with newer more energy efficient HVAC equipment is an event that can result in energy savings. Likewise, the installation of energy efficient lighting, refrigeration, or cooking equipment can also constitute an energy impacting event.

Operational changes can also constitute events that impact energy consumption. For example, changing store hours may result in lower or higher energy usage. Changing the HVAC setpoint schedule for one or more zones can also affect energy usage.

Energy savings initiatives, such as employee education about energy savings, a companywide or storewide energy savings awareness week, or employee incentives to save energy can also constitute energy impacting events. Sales promotions that cause an increase in customer traffic can also constitute an energy impacting event. Changes to business logistics and schedules, such as how often shipments of products are scheduled to arrive, or how much and how long inventories of perishable food is stored, refrigerated, and stocked can constitute an energy impacting event.

Less obvious events can also impact energy consumption. For example, a popular sporting event may result in lower customer traffic while a heat wave or large storm may result in lower or higher customer traffic depending on when the weather event occurred. The amount of customer traffic can affect how often doors and refrigeration units are opened and closed and thus correlate to higher or lower energy consumption.

Measuring the magnitude of the energy demand and consumption and correlating it with events can assist in making judicious energy management business choices. Investigating and identifying the details of specifically how these events affect energy demand and consumption helps facility operators replicate efficient energy practices and choices across multiple facilities. One way to determine the effects of energy impacting events is to isolate the specific sub-metered, circuit-level energy loads related to the event. For example, in the case of an overlapping HVAC retrofit and lighting retrofit project, an operator could look at each corresponding sub-metered channel (e.g., the HVAC load channel and the lighting load channel) to determine how much each channel contributed to overall energy savings. Having a repository of all energy impacting events in one central system, i.e., the EMS, enables an operator to conveniently and easily correlate, measure, investigate, and track multiple energy impacting events.

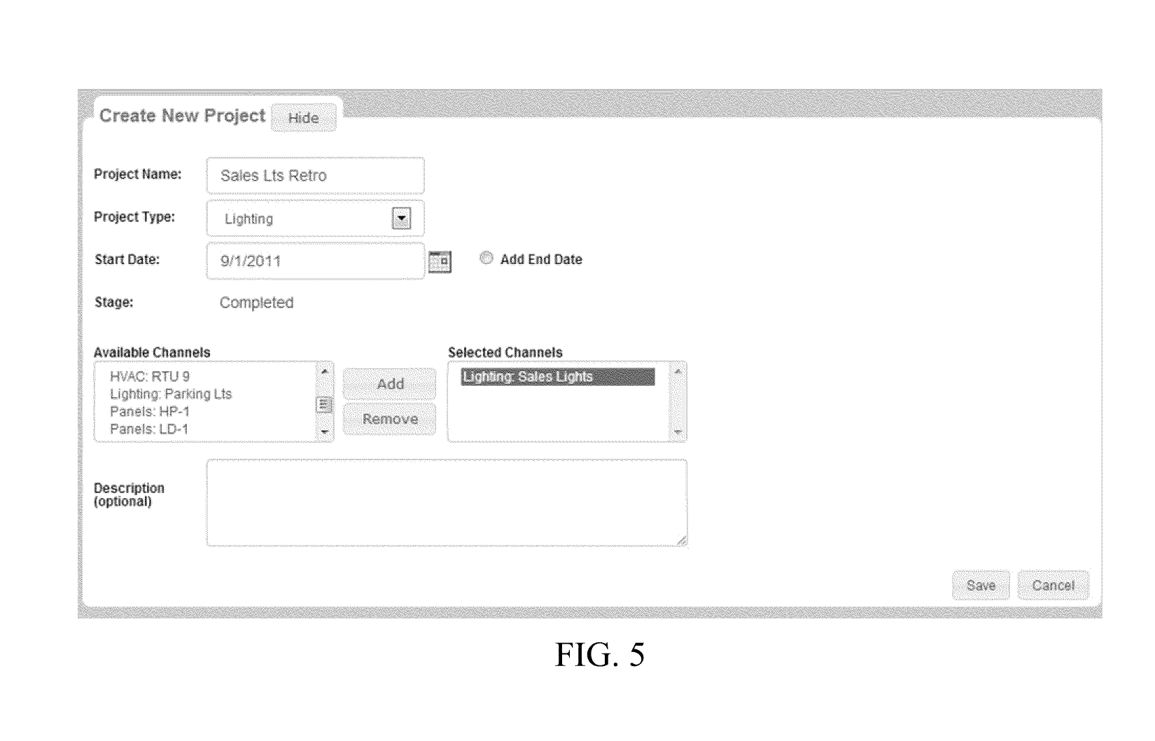

In order to track an energy impacting event (or “project”), the project must first be defined by entering project data into the EMS, either by entering data into entry screens or by importing project data in bulk. Energy impacting projects may include the following attributes entered by the operator:
name
site
type
starting date
ending date
   FIG. 5 is an example of an EMS entry screen for creating projects, which allows an operator to enter definitional project data. An operator can name a new project, select a project type, and add start and end dates to the project. Future references to this project can be keyed to this title. The operator selects from a list of project types, for example, a lighting retrofit. The start and end date may determine the “stage” of the project when compared to the present day. End dates are optional and if left blank, projects are considered “complete” the day after the start date. Both actual and planned start and end dates may be entered. Alternatively, the stage may not necessarily be determined by dates, but rather may be based on an operator's approval, workflows, or other external metrics, entered either manually or imported from other project management or financial systems.

The basic project definition includes only a name, site, and type. Such a project has no starting date and has no channel data associated with it. The status of such a project in the EMS is “planned”. The project name can serve as the identifier for the project and the site identifies to which facility the project relates. The type is useful in categorizing and grouping the projects, but may be omitted in some embodiments. With only these definitional attributes, the project can be stored in the EMS and will typically serve as a placeholder for future use. For example, a project could be planned that associates weather events with a particular site as follows:

Name=Hurricane

Type=Weather

Site=Arlington 1

At the time the project is created, the operator is unsure of the actual date or dates of the hurricane weather event, so it is left blank for further definition.

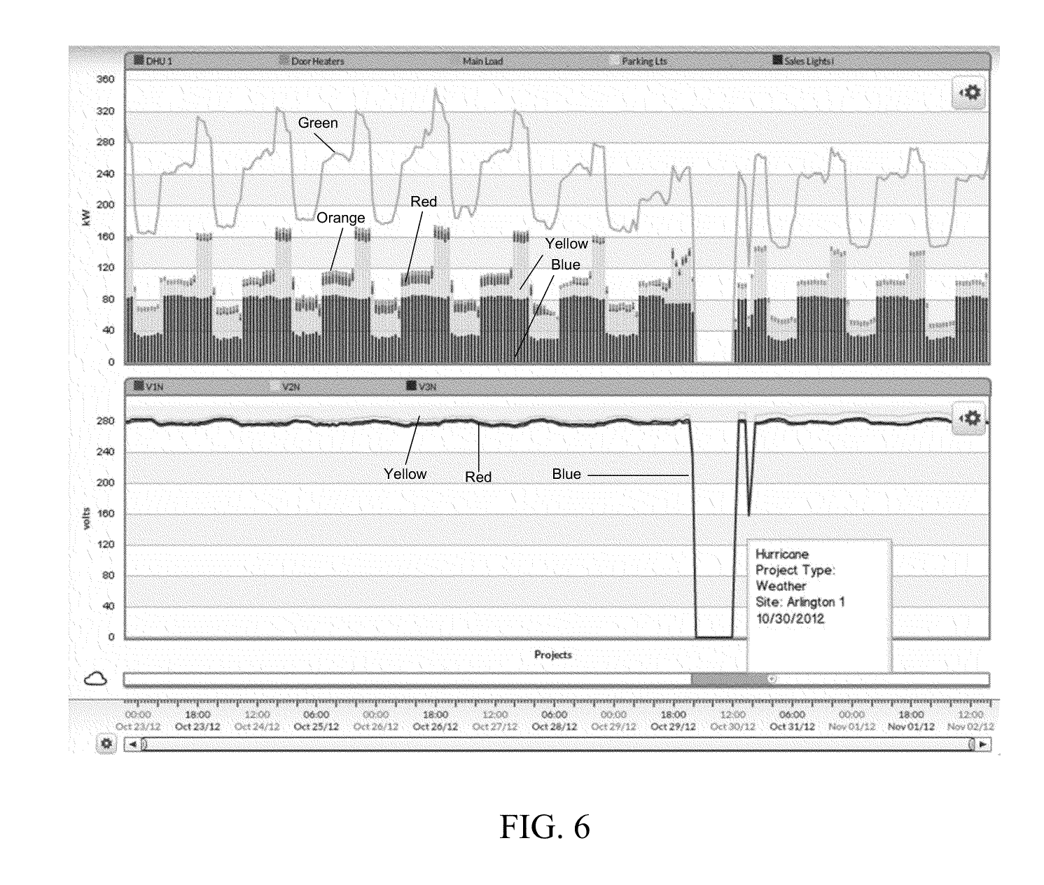

Adding a starting date to the project definition inherently associates, in time, all of channel data from the facility identified with the selected site. FIG. 6 shows a graph of daily channel data for a site associated with a project on the specified date, for the project defined as follows:

Name=Hurricane

Type=Weather

Site=Arlington 1

Starting Date=Oct. 30, 2012

As shown, a portion of the Arlington 1 site demand channel data (dehumidifying unit (DHU 1)), door heaters, main load, parking lights, and sales lights) for several days before and after Oct. 30, 2012 is shown, along with a project pop up name “Hurricane” displayed on the day of the weather event. Other data channels that are not directly related to energy use could be also displayed, such as HVAC run time, duct temperatures, CO2 concentration, door open times, etc. The data of each channel is displayed on an hourly basis thereby showing the various contributions to overall energy consumption by each channel and a channel legend identifying each channel by name and distinguishing graphical characteristics, such as color, as follows:

DHU 1=Red

Door Heaters=Orange

Main Load=Green

Parking Lights=Yellow

Sales Lights=Blue

The graphical data could also be displayed at granularities other than hourly, e.g., 15 min., daily, weekly, etc. Also shown are the mainline 3 phase voltages V1N, V2N, and V3N, identified by the colors red, yellow, and blue respectively. As can be seen, at approximately 12 AM on Oct. 30, 2012, demand and voltages dropped to zero, indicating that a power outage occurred and power was not restored until approximately 6 PM on that same day.

The pop up in FIG. 6 spans a 24 hour period and displays at least the project name and start date, but may also include the project type and site, or other information related to the project. The end date in the pop up is left blank indicating that this is a one day event. Alternatively, if the weather event was a multiday event, a specified end date could be included in the project definition, as follows:

Name=Hurricane

Type=Weather

Site=Arlington 1

Starting Date=Oct. 28, 2012

Ending Date=Oct. 30, 2012

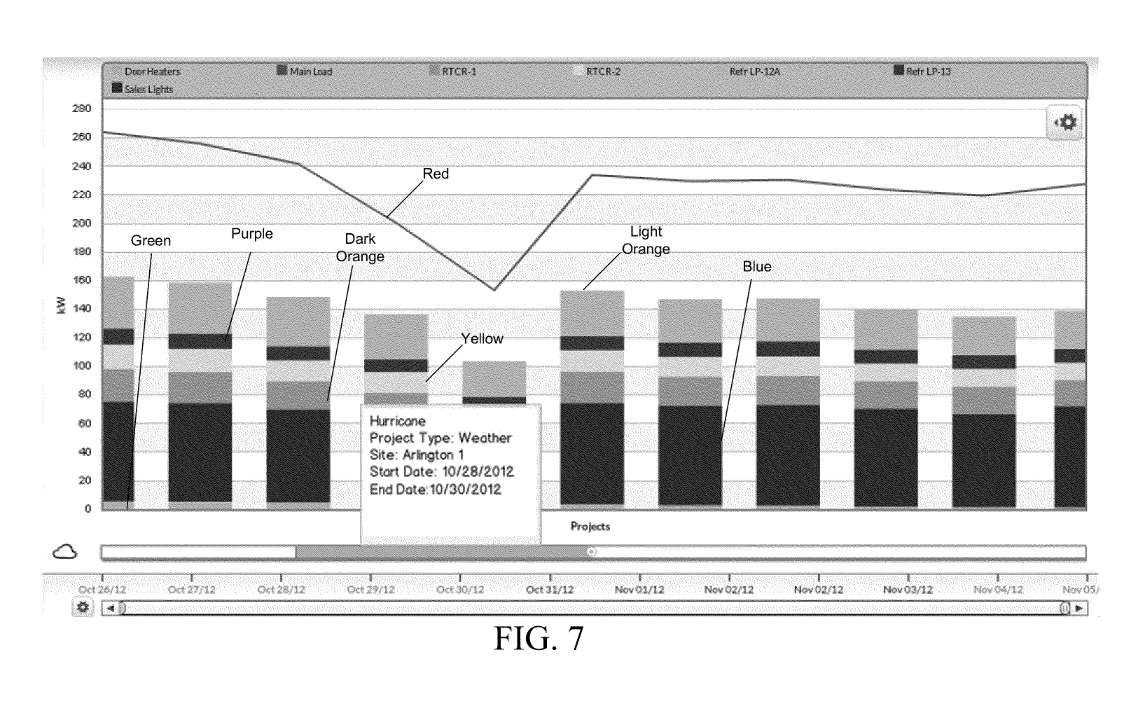

FIG. 7 shows a graph of average daily demand channel data over a multi-day period. In this case, the pop up spans a 3 day period rather than a one day period. To further investigate and understand the correlation between the event and channel data, the operator may also eliminate selected channels from the graph, or add additional channels to the graph, until the correlated channel(s) are identified. In this case, the following channels are identified by the color legend as follows:

Door heaters=Green

Main Load=Red

RTCR-1=Dark Orange

RTCR-2=Yellow

Refrigerator LP-12A=Light Orange

Refrigerator LP-13=Purple

Sales Lights=Blue

Graphs such as those shown in FIG. 7 may indicate elevated energy demand for the isolated refrigeration unit channels, a possible indication that refrigeration doors were being opened and closed more often on the days leading up to the event. During the event, average daily demand drops significantly, due again to power outages at the site which would be more visible at hourly or 15 min granularity views of the graph (not shown).

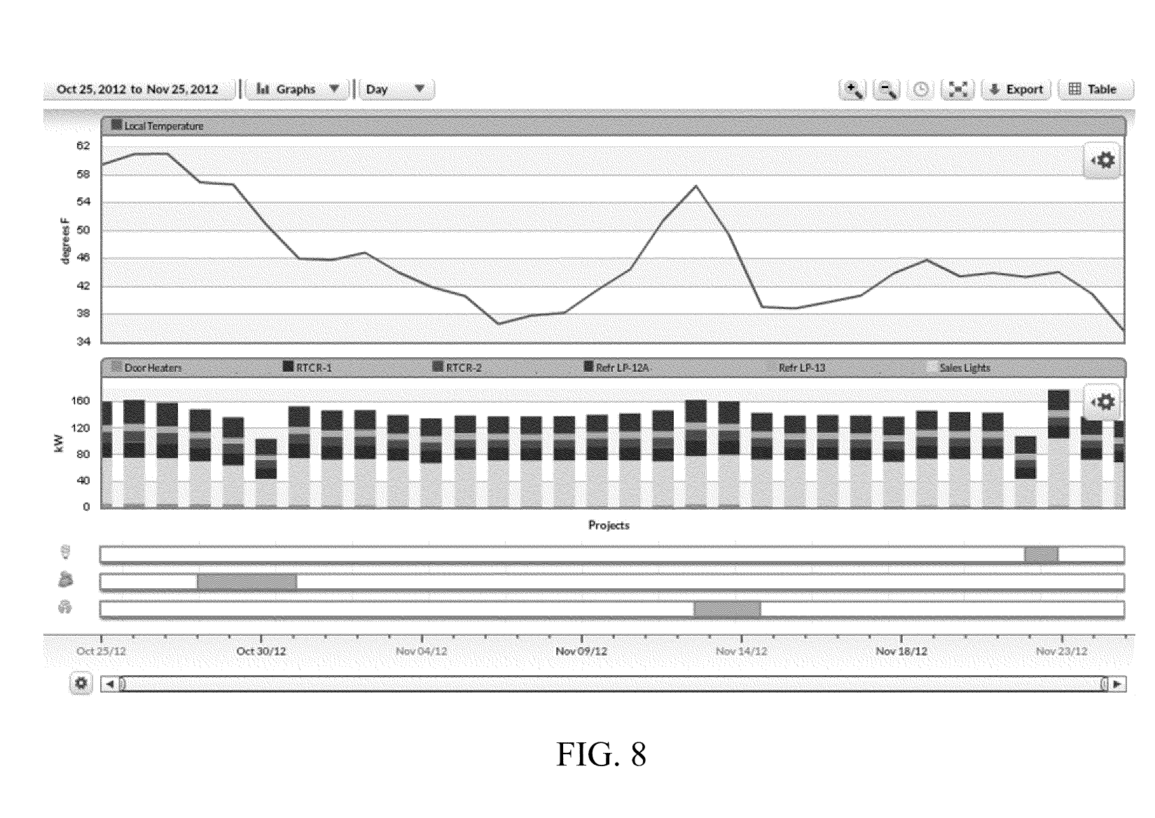

As another example, FIG. 8 shows demand channel data as well as outside temperature for a site over a month-long period. Similar to the previous example, project popups are overlaid with the channel data for analysis. If the graph spans dates associated with other projects, popups for those projects will show up as well, allowing the operator to view multiple projects associated with the same site. Projects appear on different “tracks” based on their project type as identified by icons associated with each track, and hovering over the shaded bar corresponding to the project period will bring up the project details as shown in FIGS. 6 and 7.

EMS alarms and configuration events can also be automatically considered “projects” or “events.” For example, selectively or by default, the EMS can designate an alarm as a project and the duration (the time between when the alarm was opened and closed) would represent the project's start and end times.

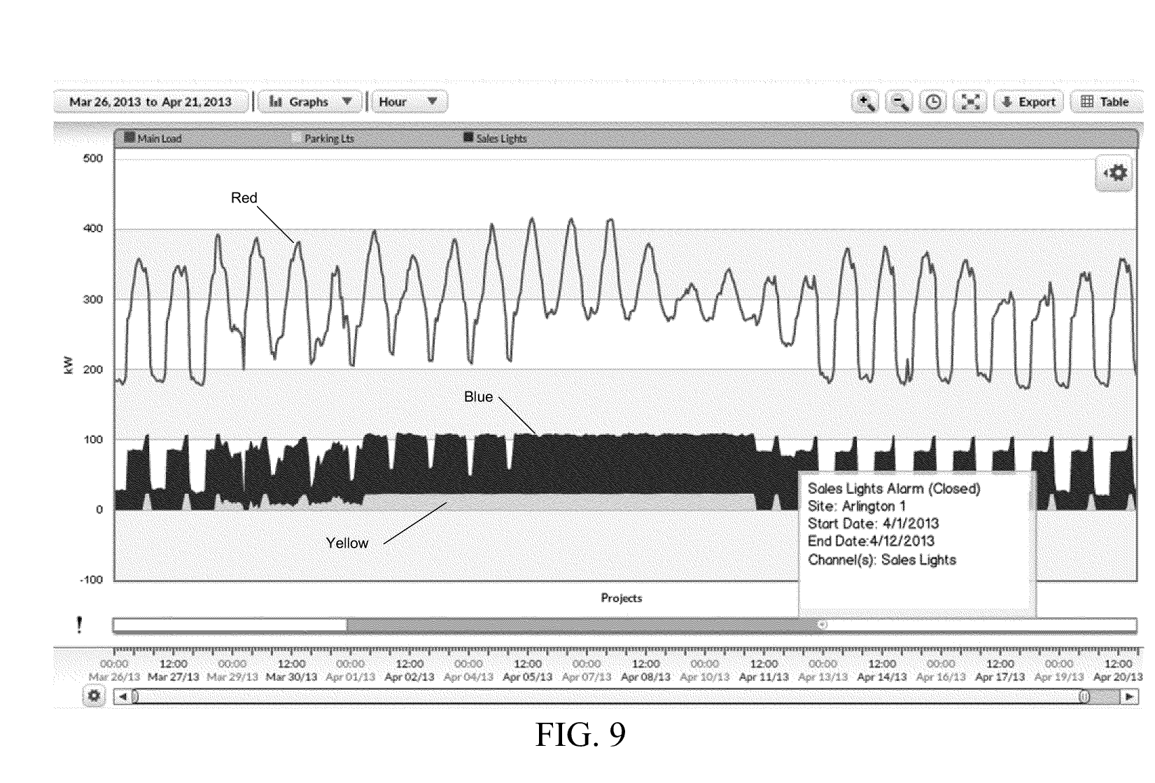

FIG. 9 is a graph of main load (Red), parking lights (Yellow), and sales lights (Blue) channels over multiple days before and after the triggering of a sales light alarm. As shown, when viewing data associated with an alarm definition, the alarm will pop up in the “project overlay” area on graphs to assist the operator in keeping track of and investigating the cause of the alarm. In this instance, a “project” is automatically created with the following definition:

Name=Sales Lights Alarm

Type=Alarm

Site=Arlington 1

Channel(s)=Sales Lights

Starting Date=Apr. 1, 2013

Ending Date=Apr. 12, 2013

Once an alarm instance triggers, the operator can simply refer to the graph of the data channel and see the alarm project overlay. This approach makes visualizing and tracking alarms easier. It also makes identifying the cause of alarms easier. Simply viewing the channel or channels that caused the alarm to trigger may not provide enough information to understand the underlying cause of the alarm. As shown in FIG. 9, by looking at additional sub-metered channel data associated with the alarm period, particularly just before the alarm was opened, and just after the alarm was closed, an operator can investigate the potential causes of the alarm and devise ways to prevent the alarm. In the case shown, it is noted that on the same days that the sales lights exhibited a larger than expected energy usage, the parking lot lights exhibited the same condition. By looking at this parking lot light channel that was not directly tied to the alarm definition, an operator could conclude that there was nothing wrong with the sales light schedule, but rather, the facility staff overrode the lighting schedule for all lights and forgot to turn them off on several consecutive evenings.

### Baselines and Tracking Projects Impacts Against a Goal

Determining whether to invest in a capital improvement project is a fundamental business problem. Reliance on using rule of thumb or gut instinct is ill advised when making such choices, particularly when there are competing investment options. Even making relatively straightforward decisions, such as whether to retrofit a lighting system with energy efficient lights, can be complex. Absent objective data to back up the decision, savings opportunities can be missed or assets misallocated. One way to assess the value of such capital investments is to create a test project, for example, wherein one or more lighting zones of a facility, or portion of a facility, is retrofitted with the subject energy efficient lights and the energy savings is automatically calculated. For these types of projects, that have one or more energy load channels specifically affected by the project, those channels may also be tied to the project using the entry screen shown in FIG. 5.

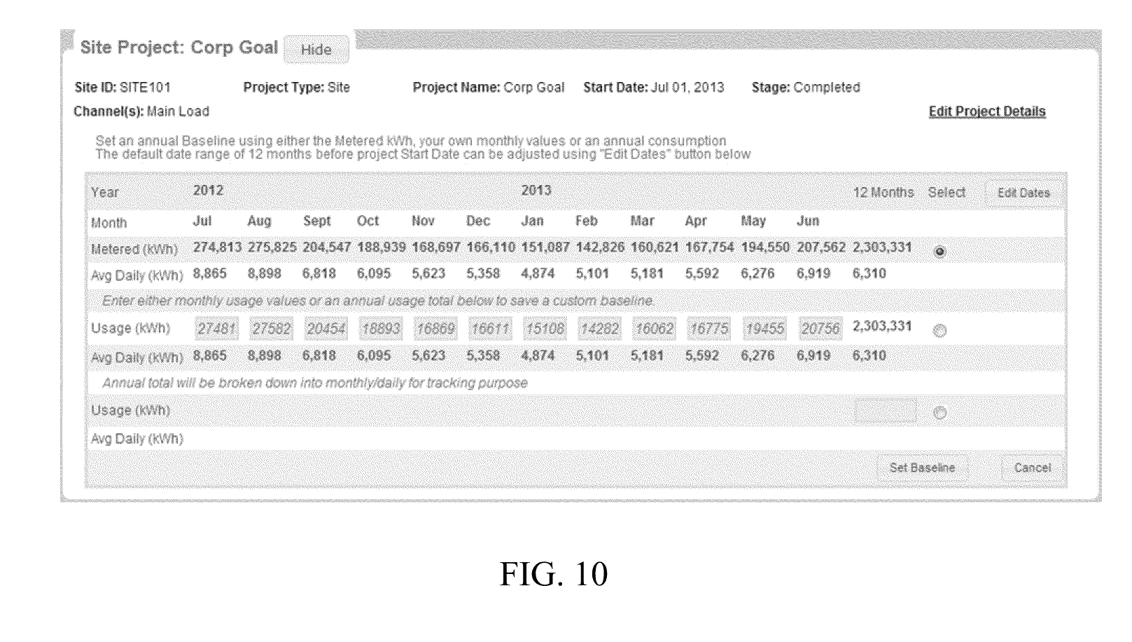

Further, a corresponding channel baseline may also be tied to the project using the entry screen shown in FIG. 10. The energy manager can automatically populate the baseline data with the usage values for the particular channels measured in the previous 12 months. If the historical data is unavailable, or if the operator wants to use data associated with another time period, annual, monthly, or daily values and/or alternative baseline dates can be manually entered by the operator. In one embodiment, the operator can simply enter an annual usage value and this will be prorated into monthly values to form the baseline. The baseline default range may be, for example, 12 months, but if less than 12 months of baseline data exists, the remaining months can be filled in with zeros or other default values. This will allow the project to be analyzed, but the full complement of results will be limited to those months where actual baseline data exists.

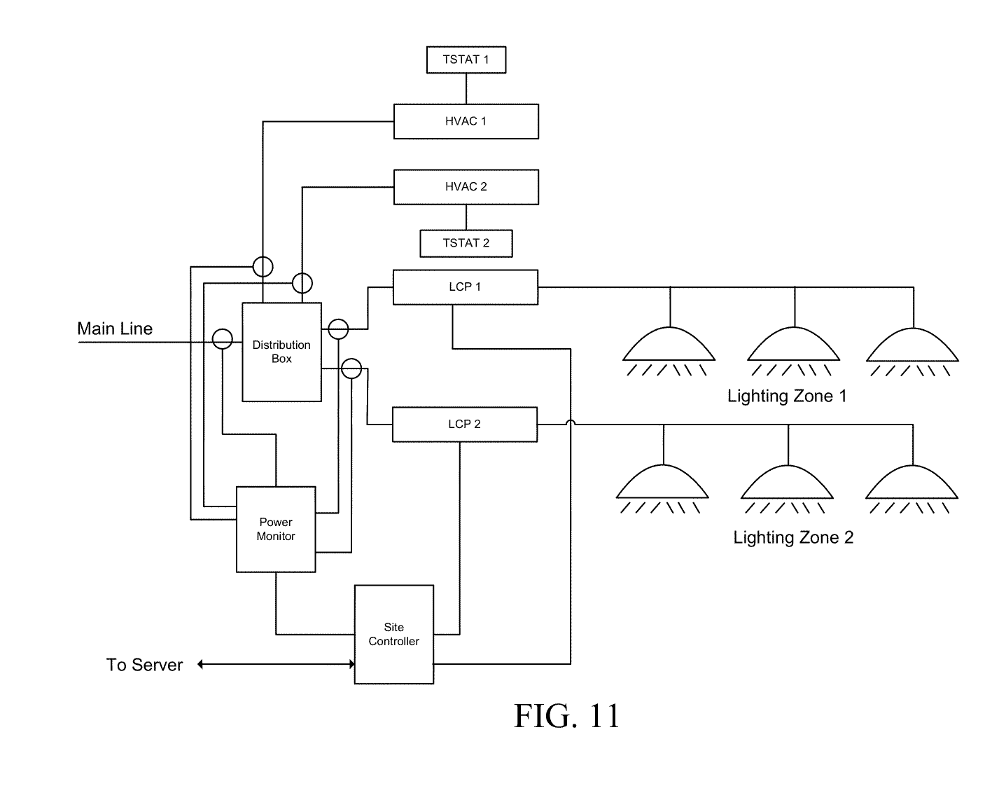

FIG. 11 shows multiple lighting zones being monitored within a facility. The energy consumption for each lighting zone is individually monitored by the EMS using CTs located at the electrical panel. Each CT is associated with a monitored channel. Lighting zones 1-2 are retrofitted with the subject energy saving lights. An operator creates a project in the EMS that isolates and tracks the electrical usage of the selected lighting zones and collects channel data for those zones. The lighting channel data is later compared with channel data from the previous year and an energy savings value is calculated. The calculated energy savings can be compared to the cost of the retrofit and a project value calculated and associated with the project.

To ascertain the impact of the lighting retrofit, a project is created using the following attributes as shown in FIG. 5:

Name=Sales Lts Retro

Type=Lighting

Channel(s)=Sales Lights

Start Date Sep. 1, 2011

To measure the effects of the project on energy consumption, a baseline must be established. In the example, if energy consumption data for the relevant channel or channels already exists, for example in the case of the lighting retrofit, then the channel data (“Sales Lights”) for the previous 12 months prior to the retrofit are used. If no channel data exists, for example in the case where sub-metering equipment was not previously installed for the channel associated with the project, then the operator can manually input baseline values into the EMS for a 12 month period. Alternatively, the operator can choose to select an annual baseline number which would then be prorated over the previous 12 months. An example of setting a baseline is shown in FIG. 10 for a “Corp Goal” project tied to the Main Load channel at a site. In the example, the operator has opted to use the first (default) option of the 12 month Metered kWh baseline. Alternative, the operator could use the second (manually entered monthly kWh values) option which pre-populates with the metered values as a starting point, or simply enter an annual kWh total in the third option. The annual kWh option would be prorated over the 12 months based on average days/month. Additionally, the operator has options to edit Project Details and/or Baseline start/end dates in this view.

Certain types of channel data are particularly sensitive to weather conditions, which makes a meaningful comparison to a baseline difficult. For example, HVAC demand varies from day to day and season to season. Day to day or season to season variations in the weather, particularly temperature, will cause the project performance results to fluctuate erratically because the channel data variations due to weather can swamp the nominal differences in energy use due to the project instance. In other words, even absent the project, it is highly unlikely that the previous year's HVAC channel data on a particular day will be close in magnitude to the next year's HVAC channel data due to variance in temperature. Even the overall long term HVAC consumption data is unlikely to be close enough to the previous year's consumption data to produce meaningful comparisons attributable to the project.

This problem can be solved by normalizing the baseline to account for differences in weather. One way to normalize for the changing weather is to adjust the baseline usage by a certain factor which is determined by a regression analysis. This analysis takes into account energy demand (in kW), heating degree days (HDD), and cooling degree days (CDD). The harder the HVAC system works to heat, the more heating degree days there were in a time period, and the harder the HVAC system works to cool, the more cooling degree days there were in a time period.

HDD and CDD data is obtained, for example from a third party weather service and regressed against HVAC power demand to find the relationship between the weather data and the HVAC power demand. The resulting regression model becomes the adjusted baseline HVAC power model and populates upon receipt of each day actual weather data.

The relationship between temperature and HVAC energy consumption may not necessarily be a simple linear function, but rather may operate as a more complex curve. By observation, the transfer function relating temperature to HVAC channel data can be ascertained and similarly applied to normalize HVAC baseline data. Similarly, any other additional factor that is uncorrelated with the project, and can be quantifiable such as humidity or the site area, can be used to normalize baseline data, thereby improving project analysis sensitivity.

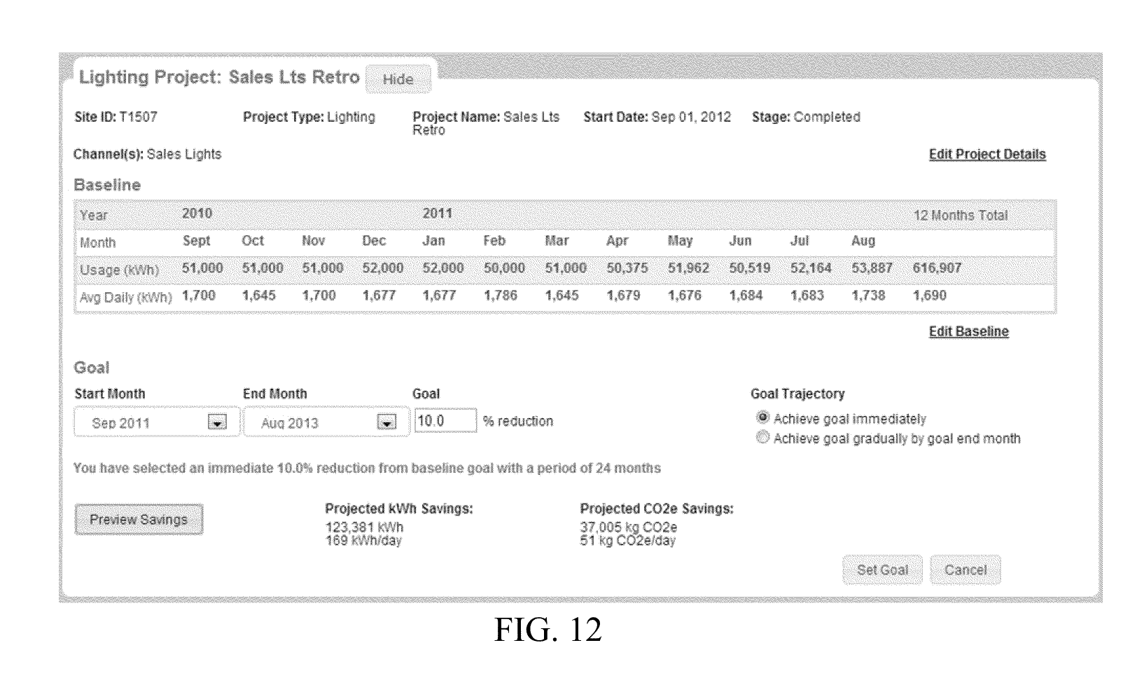

FIG. 12 is an entry screen for creating a goal or forecasting estimate for a given project, which together with the baseline data enables the operator to measure the progress of the project over time. To create a goal, a goal period (for example, a goal start month and a goal end month or goal start day or goal end day) must be specified. The goal trajectory can also be selected as either “achieve goal immediately” or “achieve goal gradually”. If achieve goal immediately is selected, the energy savings is apportioned pro rata because it is realized immediately. If achieve goal gradually, a gradual trajectory would be created to track progress on meeting the goal through the end of the goal period.

A project goal can be expressed as an immediate percentage reduction from the baseline value. In this case, because the percentage reduction from baseline for a retrofit-type project should be immediately realizable, the goal trajectory is set to immediate. Example attributes for the lighting retrofit project goal are defined as follows:

Goal=10% reduction from baseline

Trajectory=Achieve goal immediately

Alternatively, the operator can select an immediate specific average daily kWh reduction from the baseline rather than a percentage of the baseline. The goal trajectory can be set to immediate because the energy-related effects of projects like retrofits are realized right away. An example of attributes for the lighting retrofit project goal are defined as follows:

Goal=1700 kWh per day

Trajectory=Achieve goal immediately

The project goal can also be expressed as a specific annual or monthly kWh reduction forecast. As before, the reduction from baseline should be immediately realizable when the goal trajectory is set to immediate. An example of attributes for the lighting retrofit project goal are defined as follows:

Goal=620,500 kWh annual (average 1700 kWh/day for one year)

Trajectory=Achieve goal immediately

Alternatively, in some types of projects, it makes sense to set the trajectory of a project goal to be achieved gradually by goal end month, i.e., the last month specified in the goal. For example, in the case of a company-wide energy reduction initiative, such as an employee energy awareness competition or a corporate 5 year reduction goal, the goal would be achieved gradually by the end of the last month in the defined goal period and tracked.

In the case of the lighting retrofit project defined above, various graphical views of the project can be generated and displayed. For illustrative purposes, an example project is defined below for a particular site:

Name=Sales Lts Retro

Type=Lighting Retrofit

Channel(s)=Sales Lights

Starting Date=Sep. 1, 2011

Baseline=Previous 12 months (Sep. 1, 2010 to Aug. 1, 2011)

Goal=10% reduction from baseline (Sep. 1, 2011 to Aug. 1, 2013)

Goal Period=Sep. 1, 2011 to Dec. 31, 2013 (28 month)

Trajectory=Achieve goal immediately

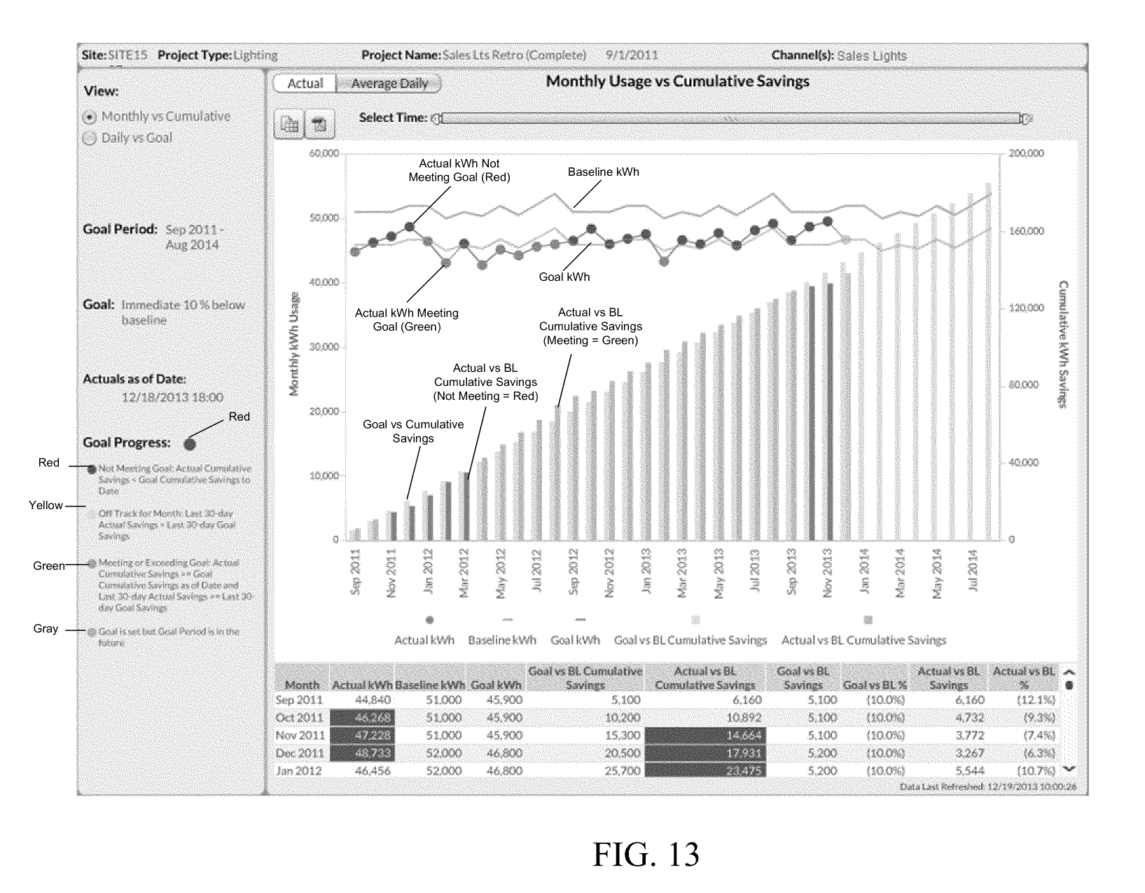

FIG. 13 is a dashboard view showing the progress of a Sales Lights Retro project. Monthly baseline, goal, and actual sub-metering usage are plotted other over the project period. When the actual data meets or outperforms the goal, the data point representing the actual data is displayed in green indicting that the goal for that month has been met. When the actual sub-metered data underperforms the goal, the data point representing the actual sub-metered data is displayed in red, indicating that the goal for that month has not been met. This allows the user to see graphically how the project has been performing over time, for example, month-to-month. A time selector at the top of the dashboard allows the user to drill into certain time periods of interest. A progress indicator showing whether or not the overall project goal is being met or is off track can also be shown for each day, month, or for the project overall. In addition, the tabular data related to the graphical data shown is also presented and exportable for further analysis.

The monthly cumulative savings is also shown as the difference between the actual and baseline data accumulated month to month. Also shown is the goal vs. baseline data accumulated month to month. When the actual cumulative savings meets or exceeds the goal cumulative savings for a particular month, the actual cumulative savings is displayed in green. When the actual cumulative savings falls short of the goal cumulative savings for a particular month, the actual cumulative savings is displayed in red.

The data can be used to identify whether the project goal is on track and to identify issues affecting the project. For example, an operator can click on a particular data point in order to pull up channel data for that particular time range. The operator can drill down from month to day to 15 minute interval levels to see why the data associated with the project may be underperforming with respect to the project goals.

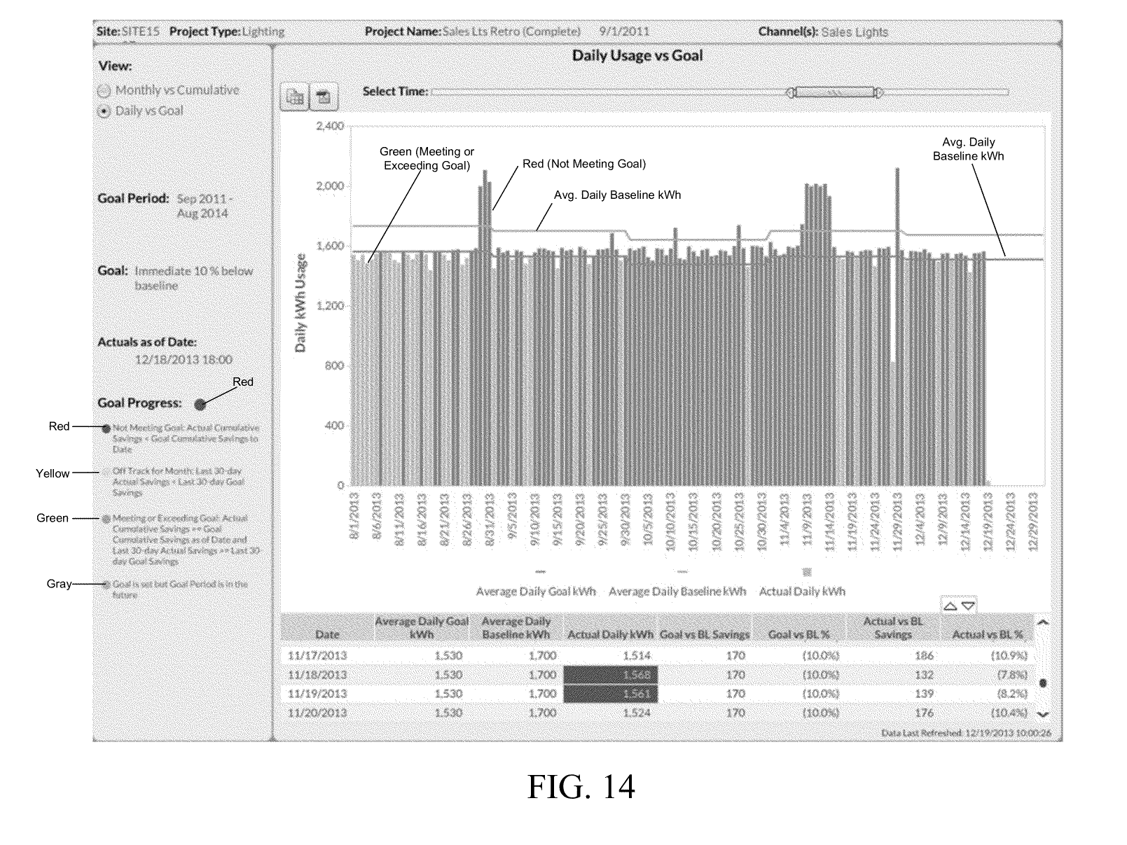

FIG. 14 is another graphical view (accessible from the dashboard shown in FIG. 13) showing the daily level progress of a Sales Lights Retro project. In this case, average daily kWh baseline and goal usage is plotted next to the actual sub-metered data for a selected time period. This example shows how an operator can drill into the previously shown monthly totals and understand the day-to-day story associated with the data. As shown, the actual data is highlighted as either red or green to indicate whether the daily goal was met or not. In this example, the operator has drilled into the most recent 3 month time range to see what has been throwing the project “off track”.

### Tracking Project Financial Metrics

In addition to measuring and tracking a project's impact on, for example, energy consumption, it is useful to quantify the value of a project in financial terms. In addition, it is useful to quantify the financial value of other operational performance metrics, such as peak demand reduction, HVAC efficiency, carbon emissions reduction, natural gas use, solar energy production and its related incentives. This will allow operators to rank projects and select which ones will be implemented throughout a fleet of facilities. One measure of merit for a project is its net present value (NPV), which sums the cash inflows and outflows of a project, each adjusted to present value, based on a user specified discount rate that represents how much value an investment or project adds to the business. When this is done, projects can be ranked according to their benefit to an organization owning a facility or facilities. In the case of a simple lighting retrofit, the cash outflow can include the initial cost of retrofitting the lights, such as the cost of the new lights, the cost of installation, the cost of disposing of the old lights. These costs would also be discounted in a manner similar to the energy savings, i.e., any cash flow not on day 1 (or period 0) requires discounting. To the extent the retrofit lights need to be replaced throughout the project period, the cost of maintenance should also be considered a cost. The cost saved by reducing energy consumption using the retrofit lights represents a cash inflow and must be discounted to a present value. Also included in cash inflows would be replacement cost and maintenance saved should the lights need less maintenance than the previous lighting. Assigning a value to the cost of energy saved requires the EMS to have data reflecting the cost of energy during the project period.

Another measure of the value of a project is the internal rate of return (IRR). The IRR is the discount rate of a project assuming that the NPV of that project is set to zero. A project with a higher IRR is generally more desirable, as the project investment has a higher return than a project with a lower IRR. Generally, if the cost of money is greater than the IRR of the project, the project should not be undertaken.

Another measure of the value of a project is the simple payback period. The simple payback period is time it takes to pay back the original cost of the project.

Regardless of the metric used to quantify an energy project's value, to do so accurately requires the collection of sub-metering energy usage or near real time monitoring data as well as baseline data in order to calculate the net cash inflows associated with energy demand or operational savings. Continuing the example of energy savings from previous sections, calculation of the net cash inflows associated with the previously described valuation calculations, requires the cost rate of energy must to be specified. In its simplest form, savings can be calculated based on the following formula over the appropriate period:

Savings=(Baseline (kWh)−Actual (kWh))*Cost of Energy ($/kWh), where the kWh is derived from the kW interval data and the Cost of Energy is based on the average cost/kWh derived from billing data.

More accurate rating formulas can also be used. Such rating formulas consider time of use criteria, tier levels, peak demand charges, ratchet provisions, or other complex billing criteria. To accurately calculate savings, the same billing criteria must be applied to both the baseline and actual energy usage. To effectively use these complex billing criteria, the mainline consumption and demand data may also need to be factored into the calculation because their levels may affect the rate that is applied to the particular channels that have been tied to the project. For example, a nominal reduction in energy savings resulting from a particular project may avoid triggering a ratchet, or avoid a demand change, resulting in a disproportionate energy cost savings. Conversely, a nominal increase in energy use resulting from a particular project may trigger a ratchet, or cause a demand change, resulting in a disproportionate increase in energy cost.

Cash outflows may be entered into the EMS as a simple lump sum amount, such as the initial cost of a lighting retrofit (capital investment), or as a more complex serious of outflows representing both the initial and ongoing costs of the project. For NPV calculations, a discount rate must also be specified. Using the start and end date associated with the Goal Period (tracking period), the system can calculate estimated NPV, IRR, and payback periods for any project with a baseline and goal. Performing the valuation calculations as the project progresses can allow an operator to be alerted to project trends and provides the opportunity to make adjustments to the parameters of the project before the project is concluded.

In the example of a lighting retrofit, the NPV can be calculated according to the following formula:

$$NPV = {\sum }_{n = 0}^{∞} \frac{{C}^{( n )}}{{( 1 + {R}_{n} )}^{t}} + {\sum }_{t = 0}^{∞} \frac{{S}^{( n )}}{{( 1 + {R}_{n} )}^{t}}$$

C^{(t)} are the capital costs (outflows) for the lighting retrofit

S^{(t)} are the savings (inflows) for the lighting retrofit

Rₙ is the discount rate at the time of a particular inflow and outflow

t is the time since the initial capital investment.

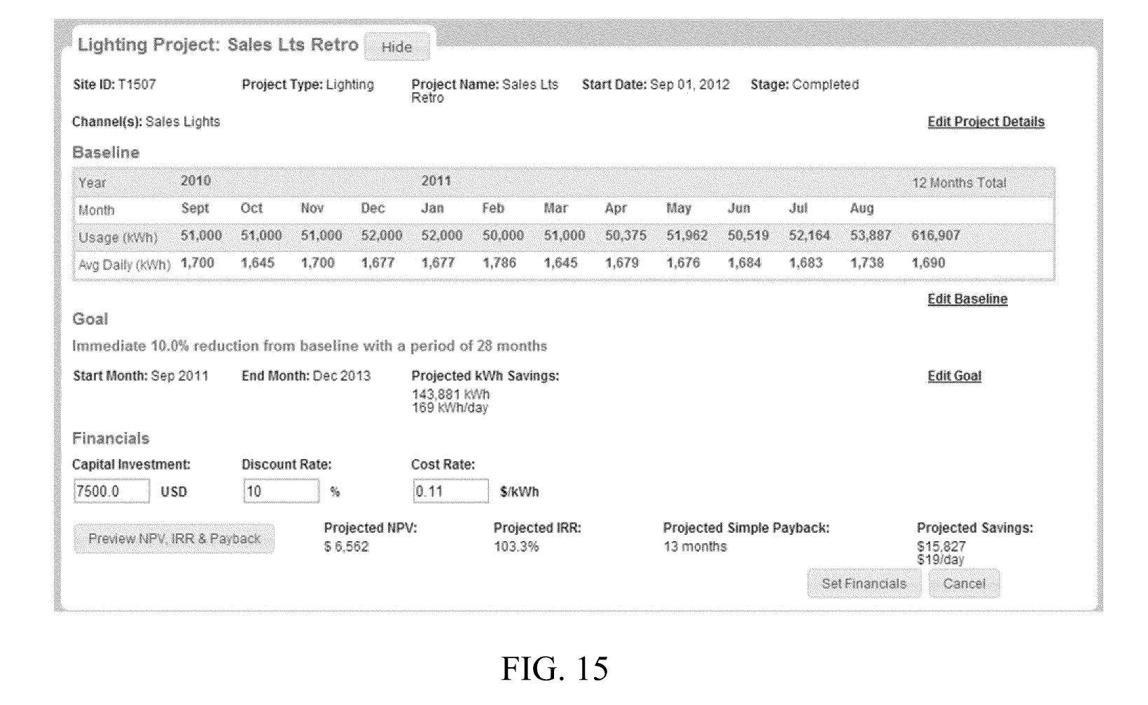

FIG. 15 is an example entry screen for defining the financial metrics for valuating a project. An operator can enter the financial start and end dates, project investment costs, discount rate, and energy cost rate values, which are necessary to perform NPV, IRR, and breakeven calculations.

To set up the illustrative lighting retrofit project, the following parameters may be entered using the entry screens in FIGS. 5, 10, 12, and 15:

Name=Sales Lts Retro

Type=Lighting Retrofit

Channel(s)=Sales Lights

Project Start Date=Sep. 1, 2011

Baseline=Previous 12 months (September 2010 to August 2011)

Goal=Immediate 10% reduction from baseline
Goal Start Month=Sep. 1, 2011
Goal End Month=Aug. 31, 2013

Initial Capital Investment=$7,500

Discount Rate: 10%

Energy Cost Rate ($/kWh)=$0.11/kWh

At or after the financial start date, energy savings is calculated based upon the difference between the actual sub-metered channel data (Sales Lights) and the baseline sub-metered data for the same channels. The monetary energy savings is calculated based on the current energy rate and, assuming that there actually is an energy savings, inflows are calculated. In cases where the actual sub-metered data was the same as the baseline data, the inflows would be zero and in cases where the actual sub-metered data was greater than the baseline, the inflows would negative. In the latter case, the NPV of the project would be negative.

At any given time, the NPV of the project can be calculated using the NPV formula specified above, the inflows calculated by the system, outflows specified by the operator, and the discount rates specified by the operator.

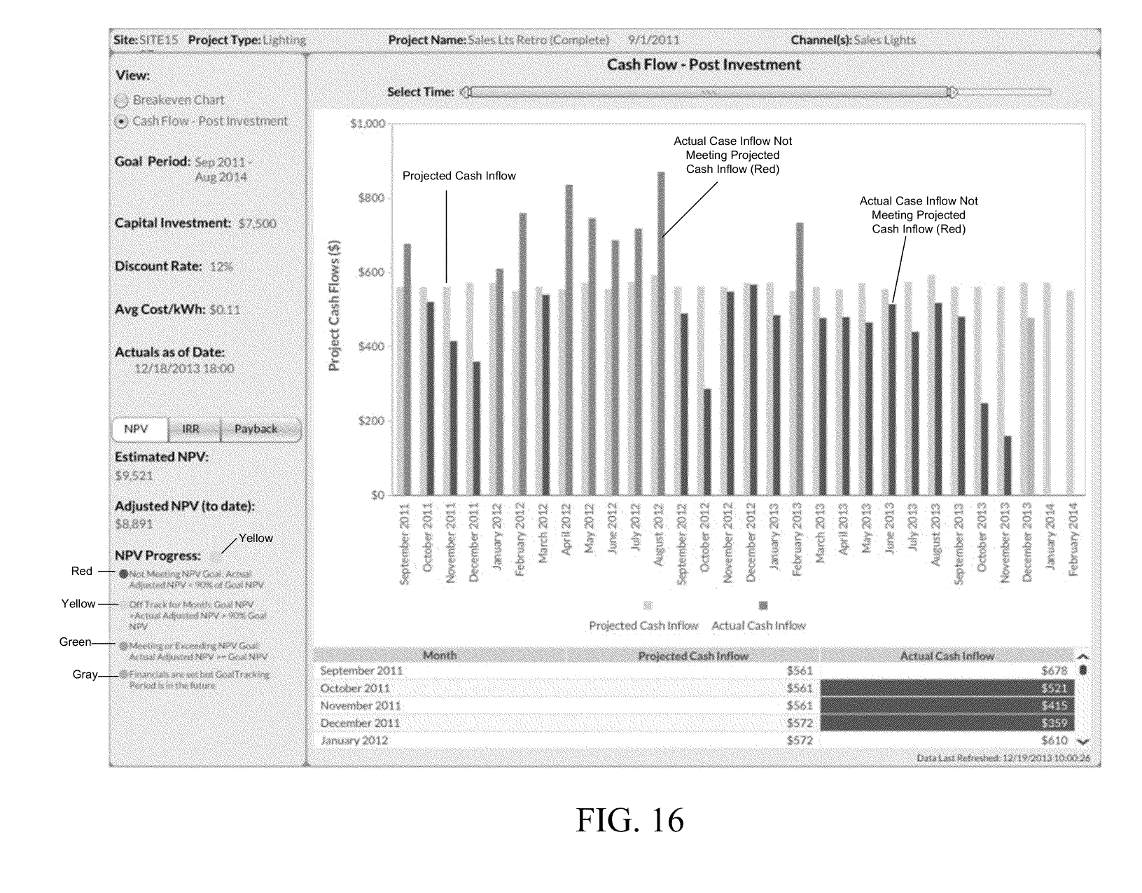

FIG. 16 is an example of a Financial Tracking Report showing cash inflows and outflows, as well as financial metrics of the project. The report includes a display of the project attributes, such as project type, name, start date, and channels. The report also includes a display of financial attributes, such as capital investment, discount rate, and cost of energy. The report further includes a graph that shows the actual and projected total cash inflows and outflows, as well as the actual and projected net cash outflows and inflow. FIG. 16 further displays the estimated NPV and actual calculated NPV to date. The project's estimated IRR, actual calculated adjusted IRR to date, or simple payback amount can also be selected by the user and displayed in place of or in conjunction with one or more of the other financial metrics.

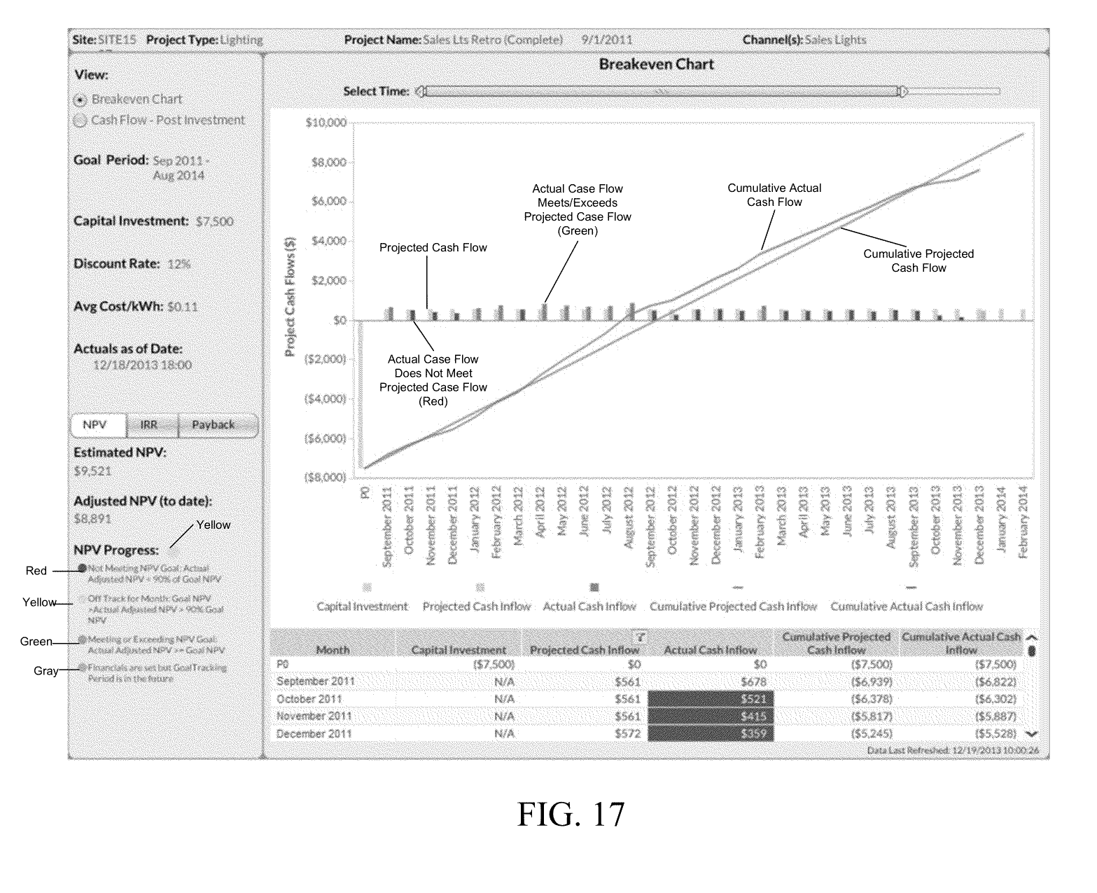

FIG. 17 is shows another view of the Financial Tracking Report when a breakeven chart is selected. The breakeven chart shows projected and actual total cash inflows and outflows, as well as the actual and projected net cash flows and cumulative cash flows. This chart shows graphically when, or if, a breakeven point has or is projected to occur.

### Using Project Inventory to Rank and Compare Across Projects

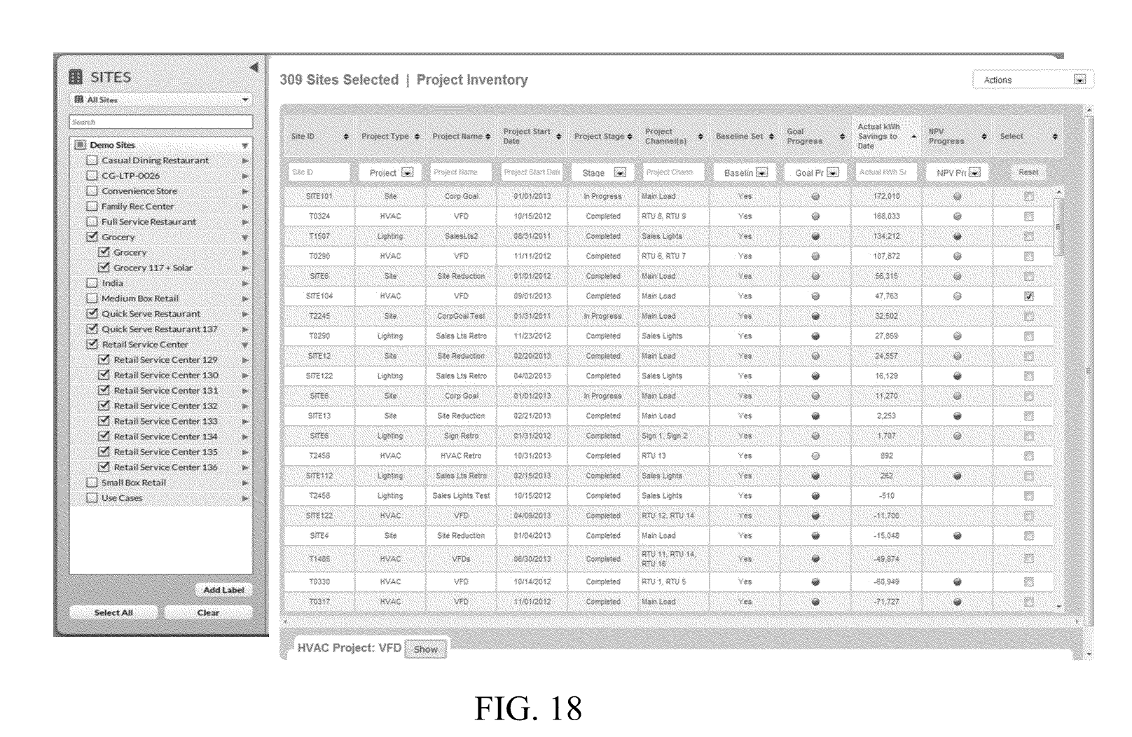

Decisions regarding whether to undertake an energy-related project must be made in consideration of other energy savings projects. It is therefore desirable to easily and conveniently display an inventory of the various projects as they progress. FIG. 18 is a graphical display of a project inventory within the EMS showing information about the various projects. Displayed are the Site ID, Project Type, Project Name, Project Start Date, Project Stage, Project Channel(s), Baseline Set, Goal Progress, Actual kWh Savings to Date and NPV progress. Other data columns, such as Site City/State/Address, Site Square Footage, Projected kWh Savings, Actual kg CO2 Savings to Date, Projected $ Savings, Projected NPV, Goal Start Month, Goal End Month, Projected IRR, Adjusted IRR, Capital Investment, or any other project-related information, could be viewed by the operator, either as default or ad hoc. Data in this view is populated in real time allowing an operator to assess the status and relative progress and value of one or more energy savings projects. The project inventory can be displayed alone or in conjunction with other views, such as the financial tracking reports, goal tracking reports, or project creation and edit screens.

The project inventory screen is typically displayed in conjunction with the site selection menu. The site selection menu is shown in FIG. 18 placed to one side of the project inventory. The site selection menu provides a convenient way for an operator to populate the project inventory with the projects of interest. By checking a site category, all of the sites within that category are populated within the project inventory. Individual sites can be removed or added and their corresponding projects removed or added to the project inventory accordingly.

The project inventory pane offers a variety of ways for an operator to sort, filter, and view projects. The projects can be selected using the right most column. Furthermore, projects can be filtered and sorted using the filters and ranking arrows at the tops of the columns. Selecting single projects can lead an operator to screens where they can view and update project information.

By allowing projects to be selected, filtered and sorted based on columns like Progress indicators or the Actual kWh Savings to date, the operator can be made aware of projects meeting or failing energy savings performance criteria. The project inventory pane also shows the goal progress for each project. In this embodiment, gray, green, yellow, and red identifiers are chosen to represent the progress against a goal, however, other colors, symbols, or indicators could be used. In this embodiment, a first color (e.g., gray) may indicate that a goal has been defined for the project, but the project has not yet project has not yet started. A 2^{nd} color (e.g., yellow) may indicate that the goal at risk of veering off track. A 3^{rd} color (e.g., red) may indicate that the goal is not on track to me met and is veering off track as of recent history. A 4^{th} color (e.g., green) may indicate that the goal is being met or exceeded. Likewise, NPV progress can be displayed using the same color indicators or other icons as described above.

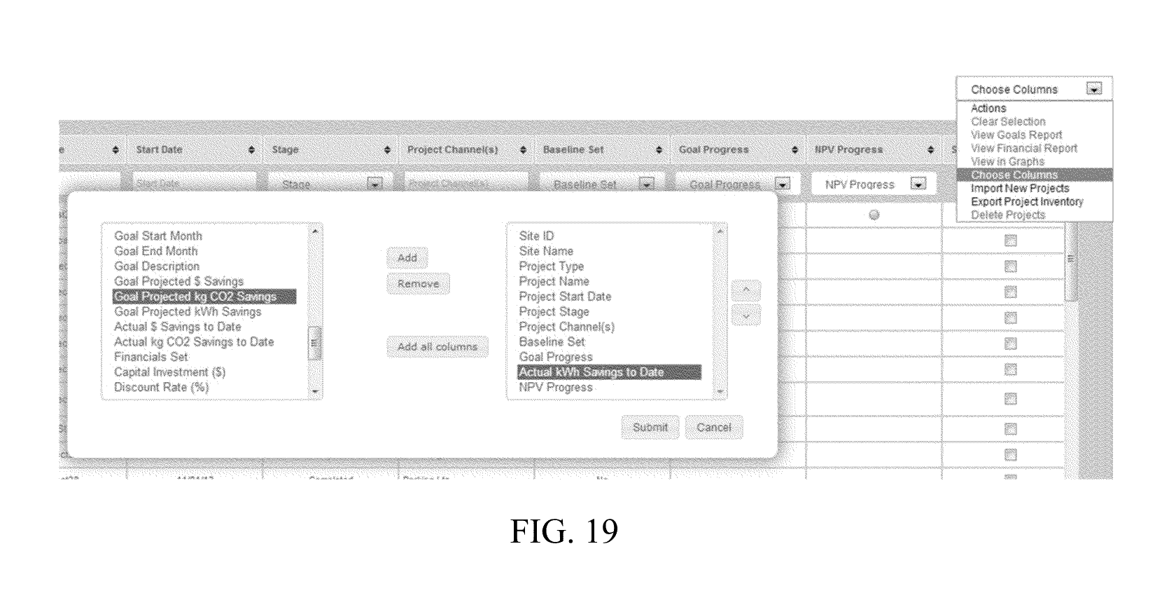

FIG. 19 shows how the operator has various options under an “Actions” dropdown to choose the columns that appear in the Project Inventory table as well as import new projects or export the data in the Project Inventory for further analysis.

### Ad Hoc Analysis

A defined project need not describe a future event. In the example of a lighting retrofit, the retrofit could have taken place in the past and an operator desires to measure its effectiveness. Setting the baseline data to the 12 month period prior to the start date of the project, and setting the goal to an expected value, the EMS could provide analysis on historic data to determine the value of a project. Furthermore, any past event, or simply a past date or date range, can be tagged as a project and the associated channel data analyzed.

Ad hoc analysis may also be performed against historical data without necessarily associating the analysis with a particular project. The system can associate and compare any channel or group of channels against itself from another time, or against another channel at any time period. This is particularly useful in quickly investigating energy use and correlations between various channels. If an association or correlation is found, a formal project can be setup in order to save and organize the results.

To initiate an ad hoc analysis, a base period start and a base period end date is selected, which defines the baseline period under analysis. A compare period is also selected, which defines against which data the comparison will be performed. The channels to be compared and a granularity (daily, day of the week, month of the year) are also selected, which determines the time periods that will be compared against each other and displayed. FIG. 19 is an example of a project tracking report showing daily comparison of actual channel data from two different time periods.

As discussed above, certain types of channels are particularly sensitive to weather data, e.g., HVAC energy consumption. For these channels, a normalizing factor is calculated that relates the weather parameter to the selected channel data. This can be done by regression analysis comparing temperature data against channel data to create a weather factor, and then multiplying the weather factor by the difference in the weather parameters at the time the baseline data was collected and the time the actual data was collected. This results in an energy consumption quantity that represents the difference in energy consumption attributable to the difference in weather. The energy consumption quantity can be subtracted from the baseline data to create normalized data for comparison to the actual data.

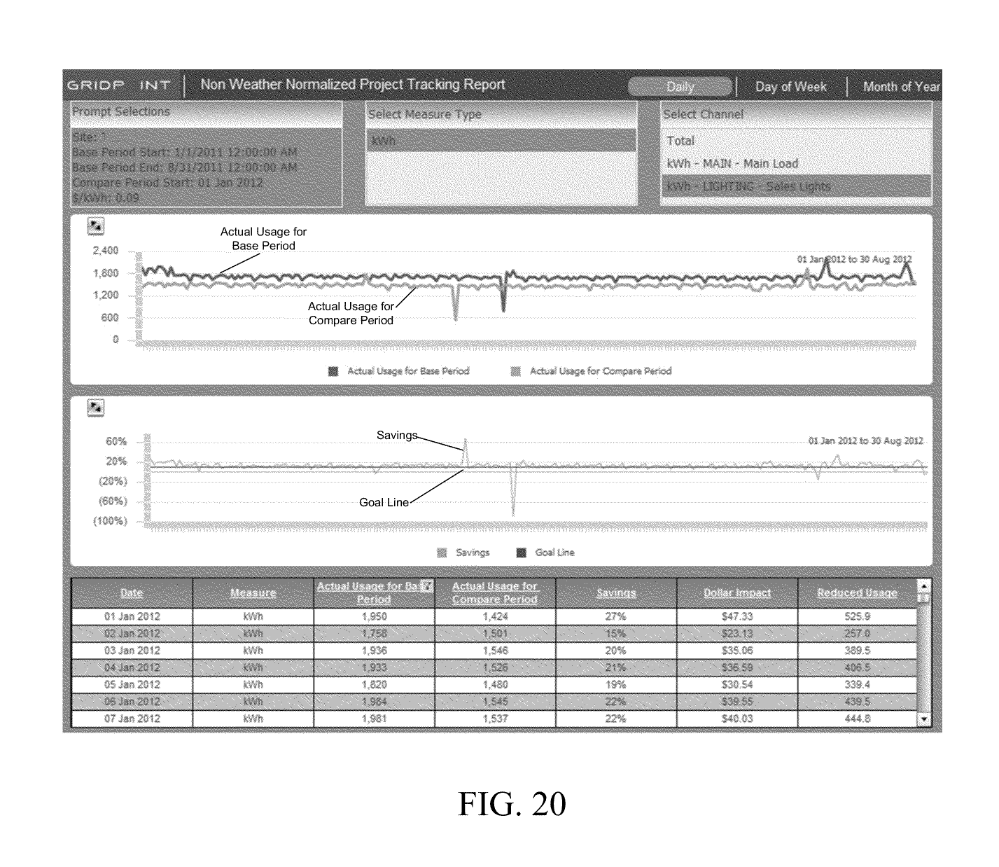

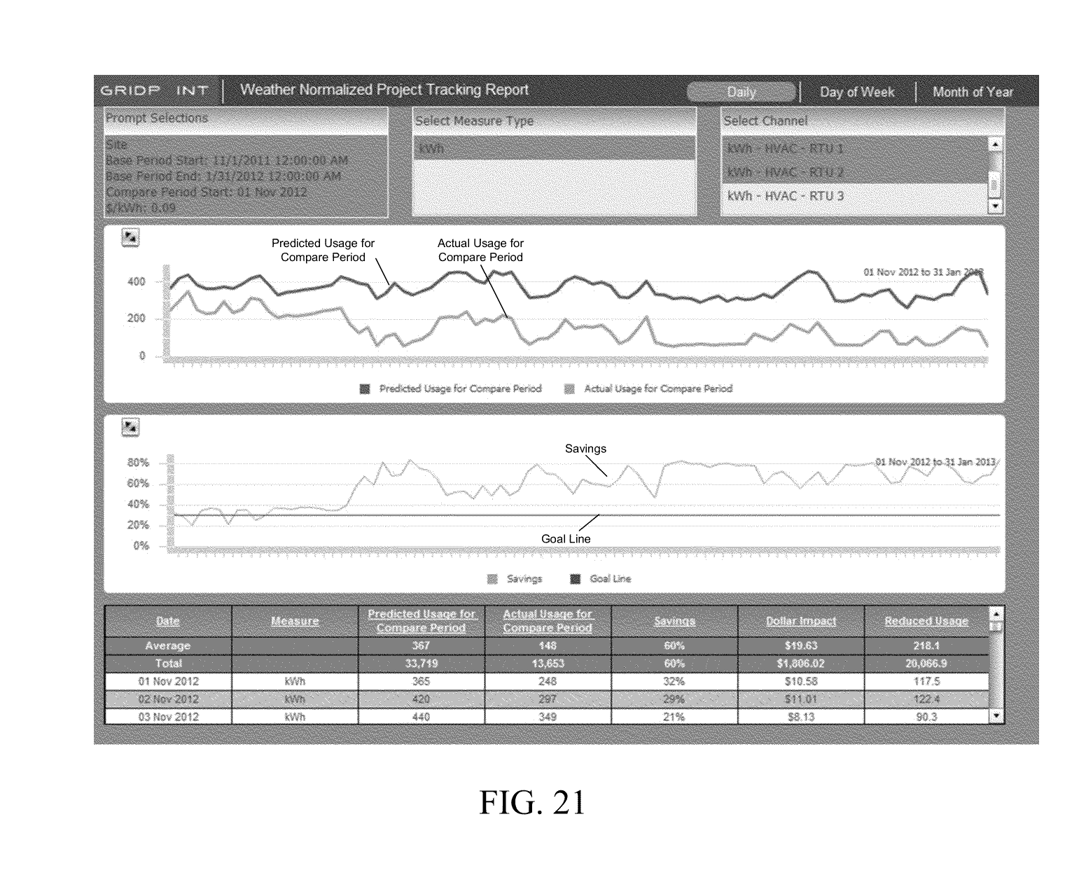

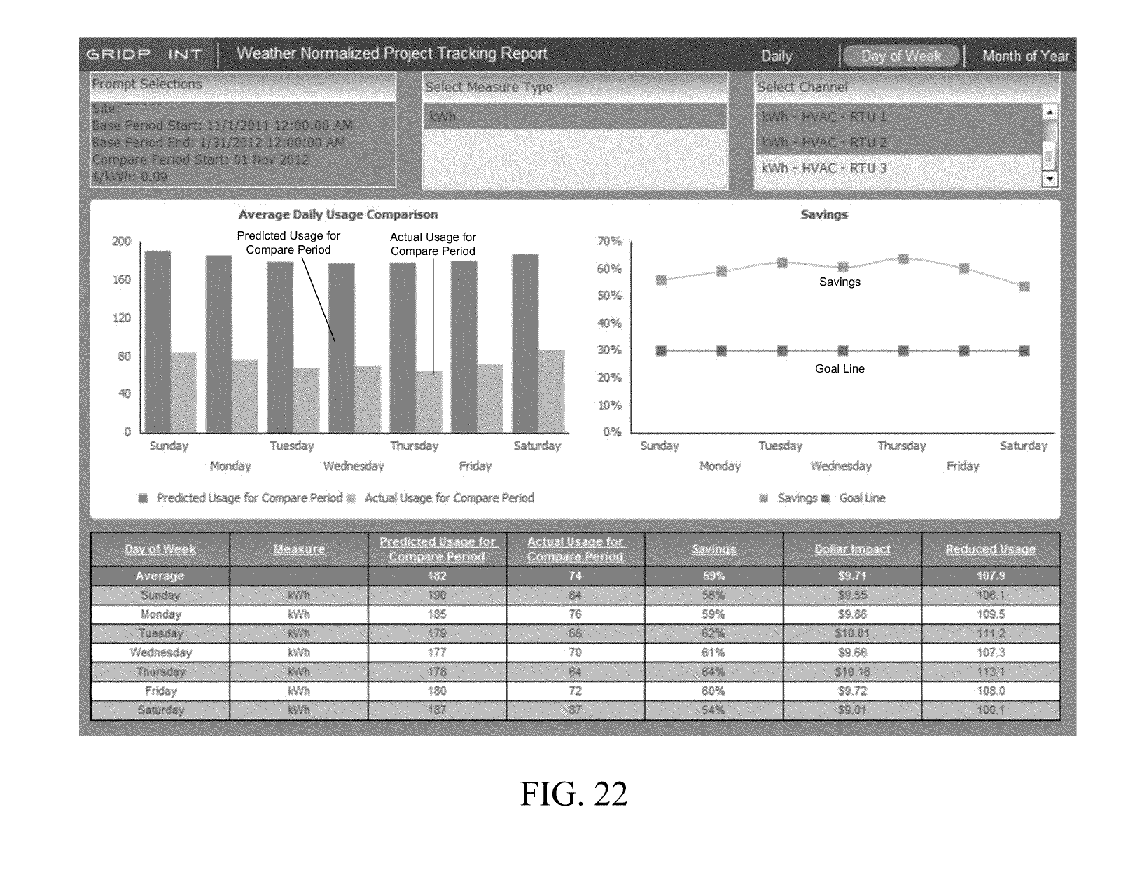

FIG. 20 is a weather normalized project tracking report showing daily comparison of normalized predicted usage and the actual usage. As shown the predicted normalized energy consumption usage is plotted against the actual energy consumption usage for the selected channel. The difference represents the reduced usage. Entering an energy rate allows the system to generate the dollar impact of the difference in energy usage. Other granularity comparison can be selected. For example, FIG. 21 is a weather normalized project tracking report showing day of the week comparison of normalized predicted and actual usage and FIG. 22 is a weather normalized project tracking report showing month of the year comparison of normalized predicted and actual usage.

Ad hoc analysis can also be performed with non-weather related data, such as sales lighting. In these cases, the baseline data is not normalized.

The present invention is described above with reference to block diagrams and operational illustrations of methods and devices for tracking energy or operational impacting events and projects in an energy management system. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although the present invention has been described in considerable detail with reference to certain preferred versions thereof, other versions are possible. Therefore, the spirit and scope of the appended claims should not be limited to the description of the preferred versions contained herein. The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

1.-9. (canceled)

10. A method of tracking progress of an energy impacting event at a facility using an energy management system, wherein one or more energy consuming endpoints of the facility are sub-metered and time series channel data from the one or more sub-metered energy consuming endpoints is transmitted to the energy management system, the method comprising:
creating a project within the energy management system by entering project definition attributes, the project definition attributes including at least a site identifier, a project identifier, a start time, and one or more identifiers associated with channel data from one or more sub-metered energy consuming endpoints;
associating a set of time series baseline data with the time series channel data of the one or more sub-metered energy consuming endpoints, the baseline data having time stamp attributes spanning a period of time before the project start time;
creating a set of time series goal data and associating it with the one or more sub-metered energy consuming endpoints, the goal data having time stamp attributes spanning a set period of time on or after the project start time during which impacts are to be calculated, wherein each data point in the set of time-series goal data has a corresponding data point in the set of time series baseline usage data;
receiving actual time series data from the one or more sub-metered energy consuming endpoints, the actual time series data having time stamp attributes spanning a period of time on or after the project start time;
determining a set of energy impact values by calculating the difference between one or more data points in the set of actual time-series data and the corresponding one or more data points in the set of time series baseline data;
determining whether one or more of the energy impact values of the set of energy impact values exceeds the corresponding one or more data points of the set of time series goal data; and
simultaneously displaying the time-series baseline data, the time series goal data, the actual time series data, and an indication of whether each of the one or more of the energy impact values exceeds the corresponding one or more data points of the set of time series goal data.

11. A method of claim 10, further comprising:
calculating the sum of two or more of the time series baseline data points to form a cumulative baseline value;
calculating the sum of two or more of the time series goal data points to form a cumulative goal value;
calculating the sum of two or more of the time series actual data points to form a cumulative actual value;
calculating, for one or more periods of time, the difference between the actual cumulative value and the cumulative baseline value to determine a cumulative project impact value;
calculating, for one or more periods of time, the difference between the cumulative project impact value and the cumulative goal to determine whether the cumulative goal was exceeded by the cumulative project impact value; and
displaying, for one or more time periods of time, a determination of whether the cumulative goal was exceeded by the cumulative project impact value.

12. A method of claim 10, wherein the set of time series baseline data is derived from past actual data of the one or more energy consuming endpoints.

13. A method of claim 12, wherein the set of time series baseline data, derived from past actual data of the one or more energy consuming endpoints associated with the channel data identifier, is automatically populated into the set of the time series baseline data when the channel data identifier is selected for the project.

14. A method of claim 13, wherein the set of the time series baseline data is manually edited.

15. A method of claim 10, wherein the set of time series baseline data is not derived from the past actual data.

16. A method of claim 10, wherein the set of time series baseline data is normalized based on one or more factors uncorrelated with the site impacting event.

17. The method of claim 16, wherein the one or more factors includes temperature.

18. A method of tracking financial progress of an energy impacting event at a facility using an energy management system, wherein one or more energy consuming endpoints of the facility are sub-metered and time series channel data from the one or more sub-metered energy consuming endpoints is transmitted to the energy management system, the method comprising:
creating a project within the energy management system by entering project definition attributes, the project definition attributes including at least a site identifier, a project identifier, a start time, one or more identifiers associated with channel data from one or more sub-metered energy consuming endpoints, one or more cash outflow values, a discount rate, and an energy cost rating formula;
associating a set of time series baseline data with the time series channel data of the one or more energy consuming endpoints, the baseline data having time stamp attributes spanning a period of time before the project start time;
creating a set of time series goal data and associating it with the channel data from the one or more sub-metered energy consuming endpoints, the goal data having time stamp attributes spanning a set period of time on or after the project start time during which the project energy impact is be calculated, wherein each data point in the set of time series goal data has a corresponding data point in the set of time series baseline data;
receiving actual time series data associated with the one or more sub-metered energy consuming endpoints, the actual time series data having time stamp attributes spanning a period of time on or after the project start time;
determining a set of actual energy impact values by calculating the difference between one or more data points in the set of actual time series data and the corresponding one or more data points in the set of time series baseline data;
determining a set of an expected energy impact values by calculating the difference between one or more data points in the set of goal time series data and corresponding one or more data points in the set of time series baseline data;
calculating one or more actual cash inflow values by applying the set of actual energy impact values to the energy cost rating formula;
calculating one or more expected cash inflow values by applying the set of expected energy goal impact values to the energy cost rating formula;
calculating an actual net project cash flow by summing the one or more actual cash inflow values and the one or more cash outflow values;
calculating an expected net project cash flow by summing the one or more expected cash inflow values and the one or more cash outflow values;
calculating an actual financial metric using the actual net project cash flow and the discount rate;
calculating an expected financial metric using the expected net project cash flow and the discount rate; and
displaying an indication of whether the actual financial metric meets or exceeds the expected financial metric.

19. The method of claim 18, further comprising:
displaying the one or more actual cash inflow values; and
displaying the one or more cash outflow values.

20. The method of claim 18, further comprising:
displaying the actual net project cash flow; and
displaying the expected net project cash flows.

21. The method of claim 18, wherein the financial metric is one of net present value or internal rate of return.

22.-55. (canceled)

56. A computer program product for tracking progress of an energy impacting event at a facility using an energy management system, wherein one or more energy consuming endpoints of the facility are sub-metered and time series channel data from the one or more sub-metered energy consuming endpoints is transmitted to the energy management system, comprising:
a computer usable medium having computer readable program code embodied in the computer usable medium for causing an application program to execute on a computer system, the computer readable program code means comprising:
computer readable program code for creating a project within the energy management system by entering project definition attributes, the project definition attributes including at least a site identifier, a project identifier, a start time, and one or more identifiers associated with channel data from one or more sub-metered energy consuming endpoints;
computer readable program code for associating a set of time series baseline data with the time series channel data of the one or more sub-metered energy consuming endpoints, the baseline data having time stamp attributes spanning a period of time before the project start time;
computer readable program code for creating a set of time series goal data and associating it with the one or more sub-metered energy consuming endpoints, the goal data having time stamp attributes spanning a set period of time on or after the project start time during which impacts are to be calculated, wherein each data point in the set of time-series goal data has a corresponding data point in the set of time series baseline usage data;
computer readable program code for receiving actual time series data from the one or more sub-metered energy consuming endpoints, the actual time series data having time stamp attributes spanning a period of time on or after the project start time;
computer readable program code for determining a set of energy impact values by calculating the difference between one or more data points in the set of actual time-series data and the corresponding one or more data points in the set of time series baseline data;
computer readable program code for determining whether one or more of the energy impact values of the set of energy impact values exceeds the corresponding one or more data points of the set of time series goal data; and
computer readable program code for simultaneously displaying the time-series baseline data, the time series goal data, the actual time series data, and an indication of whether each of the one or more of the energy impact values exceeds the corresponding one or more data points of the set of time series goal data.

57. The computer program product of claim 56, further comprising:
computer readable program code for calculating the sum of two or more of the time series baseline data points to form a cumulative baseline value;
computer readable program code for calculating the sum of two or more of the time series goal data points to form a cumulative goal value;
computer readable program code for calculating the sum of two or more of the time series actual data points to form a cumulative actual value;
computer readable program code for calculating, for one or more periods of time, the difference between the actual cumulative value and the cumulative baseline value to determine a cumulative project impact value;
computer readable program code for calculating, for one or more periods of time, the difference between the cumulative project impact value and the cumulative goal to determine whether the cumulative goal was exceeded by the cumulative project impact value; and
computer readable program code for displaying, for one or more time periods of time, a determination of whether the cumulative goal was exceeded by the cumulative project impact value.

58. The computer program product of claim 56, further comprising:
computer readable program code for deriving the set of time series baseline data from past actual data of the one or more energy consuming endpoints.

59. The computer program product of claim 58, further comprising:
computer readable program code for automatically populating the set of time series baseline data, derived from past actual data of the one or more energy consuming endpoints associated with the channel data identifier, into the set of the time series baseline data when the channel data identifier is selected for the project.

60. The computer program product of 59, further comprising:
computer readable program code for receiving manually edits of the set of the time series baseline data.

61. The computer program product of 58, wherein the set of time series baseline data is not derived from the past actual data.

62. The computer program product of 58, further comprising:
computer readable program code for normalizing the set of time series baseline data based on one or more factors uncorrelated with the site impacting event.

63. The computer program product of 62, wherein the one or more factors includes temperature.

64. A computer program product for tracking financial progress of an energy impacting event at a facility using an energy management system, wherein one or more energy consuming endpoints of the facility are sub-metered and time series channel data from the one or more sub-metered energy consuming endpoints is transmitted to the energy management system, comprising:
a computer usable medium having computer readable program code embodied in the computer usable medium for causing an application program to execute on a computer system, the computer readable program code means comprising:
computer readable program code for creating a project within the energy management system by entering project definition attributes, the project definition attributes including at least a site identifier, a project identifier, a start time, one or more identifiers associated with channel data from one or more sub-metered energy consuming endpoints, one or more cash outflow values, a discount rate, and an energy cost rating formula;
computer readable program code for associating a set of time series baseline data with the time series channel data of the one or more energy consuming endpoints, the baseline data having time stamp attributes spanning a period of time before the project start time;
computer readable program code for creating a set of time series goal data and associating it with the channel data from the one or more sub-metered energy consuming endpoints, the goal data having time stamp attributes spanning a set period of time on or after the project start time during which the project energy impact is be calculated, wherein each data point in the set of time series goal data has a corresponding data point in the set of time series baseline data;
computer readable program code for receiving actual time series data associated with the one or more sub-metered energy consuming endpoints, the actual time series data having time stamp attributes spanning a period of time on or after the project start time;
computer readable program code for determining a set of actual energy impact values by calculating the difference between one or more data points in the set of actual time series data and the corresponding one or more data points in the set of time series baseline data;
computer readable program code for determining a set of an expected energy impact values by calculating the difference between one or more data points in the set of goal time series data and corresponding one or more data points in the set of time series baseline data;
computer readable program code for calculating one or more actual cash inflow values by applying the set of actual energy impact values to the energy cost rating formula;
computer readable program code for calculating one or more expected cash inflow values by applying the set of expected energy goal impact values to the energy cost rating formula;
computer readable program code for calculating an actual net project cash flow by summing the one or more actual cash inflow values and the one or more cash outflow values;
computer readable program code for calculating an expected net project cash flow by summing the one or more expected cash inflow values and the one or more cash outflow values;
computer readable program code for calculating an actual financial metric using the actual net project cash flow and the discount rate;
computer readable program code for calculating an expected financial metric using the expected net project cash flow and the discount rate; and
computer readable program code for displaying an indication of whether the actual financial metric meets or exceeds the expected financial metric.

65. The computer program product of claim 64, further comprising:
computer readable program code for displaying the one or more actual cash inflow values; and
computer readable program code for displaying the one or more cash outflow values.

66. The computer program product of claim 64, further comprising:
computer readable program code for displaying the actual net project cash flow; and
computer readable program code for displaying the expected net project cash flows.

67. The computer program product of claim 64, wherein the financial metric is one of net present value or internal rate of return.

68. The computer program product of claim 67, further comprising computer readable program code for displaying the actual and expected financial metric.

69.-92. (canceled)
